(19) United States
(12) Patent Application Publication
(10) Pub. No.: US 2014/0088988 A1
(43) Pub. Date: Mar. 27, 2014

(54) METHODS AND SYSTEMS FOR THE COLLABORATIVE DEVELOPMENT AND DISCOVERY OF WEB-BASED CLINICAL PATHWAYS

(71) Applicant: Dorsata, Inc., Lebanon, NH (US)

(72) Inventors: David Laughlin Fairbrothers, Arlington, VA (US); Philip Andrew McDonnell, San Francisco, CA (US); Daniel Peter Gibson, St. Louis, MO (US)

(73) Assignee: DORSATA, INC., Lebanon, NH (US)

(21) Appl. No.: 14/019,401

(22) Filed: Sep. 5, 2013

Related U.S. Application Data
(60) Provisional application No. 61/697,127, filed on Sep. 5, 2012.

(51) Int. Cl. G06F 19/00

(52) U.S. Cl. CPC G06F 19/327
USPC 705/2

(57) ABSTRACT

A method and system to facilitate the collaborative development and discovery of evidence-based, clinical pathways. Clinicians, medical professionals or researchers, may use the Platform to build and find clinical pathways through a graphical interface, creating relational data records between steps in pathways. Further, users of the Platform may be able to associate relevant content such as published evidence, supplemental content items (e.g., videos, images, documents, ICD-11, CPT, SNOMED Clinical Terms, and external web pages), and other associated pathways which reside in the system's database. Users of the Platform may be able organize themselves into groups and networks to develop single pathways collaboratively. Users may be able to find specific pathways in the Platform through semantic search, querying for relationships which exist inside of individual pathways. Search results may be generated for a variety of user driven data, both explicit and implicit.

### CROSS-REFERENCE TO RELATED APPLICATIONS

This application claims benefit to U.S. Provisional Patent Application No. 61/697,127, filed Sep. 5, 2012, the contents of which are incorporated by reference herein in their entirety.

### FIELD OF THE INVENTION

The present invention relates to computer based medical information systems, and more particularly to systems and methods for creating, managing and utilizing collaborative electronic clinical pathways for patient care.

### BACKGROUND OF THE INVENTION

Clinical Pathways, also known as integrated care pathways, clinical algorithms, multi-disciplinary pathways of care, pathways of care, care maps, and collaborative care pathways are one of the main tools used to manage the quality in healthcare concerning the standardization of care processes. Conventionally, Clinical Pathways reduce the variability in clinical practice and improve outcomes; pathways promote organized and efficient patient care based on the evidence-based practice; and optimize outcomes in the acute care and homecare settings. Clinical Pathways are structured, multi-disciplinary plans of care designed to support the implementation of clinical guidelines and protocols. They are designed to support clinical management, clinical and non-clinical resource management, clinical audit and also financial management. They provide detailed guidance for each stage in the management of a patient, treatments, interventions with a specific condition over a given time period, and include progress and outcomes details.

Conventional Clinical Pathways aim to improve, in particular, the continuity and co-ordination of care across different disciplines and sectors and may be viewed as algorithms because they offer a flow chart format of the decisions to be made and the care to be provided for a given patient or patient group for a given condition in a step-wise sequence.

Clinical Pathways have four main components: a timeline, the categories of care or activities and their interventions, intermediate and long term outcome criteria, and the variance record (to allow deviations to be documented and analyzed). Conventional Clinical Pathways support the introduction of evidence-based medicine and use of clinical guidelines, clinical effectiveness, risk management and clinical audit, improves multidisciplinary communication, teamwork and care planning, provide explicit and well-defined standards for care, the introduction of evidence-based medicine and use of clinical guidelines, clinical effectiveness, risk management and clinical audit, continuity and co-ordination of care across different clinical disciplines and sectors, reduce variations in patient care, improve and even reduce patient documentation, disseminate accepted standards of care; provide a baseline for future initiatives; help reduce risk; and help reduce costs by shortening hospital stays.

Conventional Clinical Pathways may not be readily accessible, appear to discourage personalized care; are typically not prescriptive; may not respond well to unexpected changes in a patient's condition; are best suited for standard conditions rather than unusual or unpredictable ones; may not be tied to clinical outcomes; may take time to be accepted in the workplace; and need to ensure variance and outcomes are properly recorded, audited and acted upon. There is a need for a web-based graphical user interface (GUI) platform for medical professionals to collaborate in building decision making pathways or algorithms, which interacts with Electronic Medical Records (EMR) systems, supports the association of information used to support each decision or step and support for dynamically updating standard clinical pathways to support unusual or unpredictable conditions.

### SUMMARY OF THE INVENTION

The invention provides a web based, collaborative clinical pathway platform (“Platform”) for creating, building and maintaining dynamic or flexible clinical pathways or algorithms.

Embodiments of the present invention may include systems and methods for finding and building clinical pathways and associating pertinent evidence and content collaboratively, including the creation of underlying relational data records, in a graphical interface.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is an illustration of the Platform according to one embodiment of the invention.

FIGS. 2-8 are exemplary illustrations of clinical pathway operations according to one embodiment of the Platform.

FIG. 9 is an exemplary illustration of a clinical pathway chart for Pulmonary Embolism according to one embodiment of the Platform.

FIG. 10 is an exemplary diagram of a diagnostic algorithm for cerebellopontine angle (CPA) lesions according to one embodiment of the Platform.

FIGS. 11-22 are exemplary illustrations of operations available for a non-mobile device accessing a clinical pathway according to one embodiment of the invention.

FIGS. 23-31 are exemplary illustrations of operations available for a mobile device accessing a clinical pathway according to one embodiment of the invention.

FIGS. 32A-320 are a schematic chart illustrating exemplary multiple operations of the Platform.

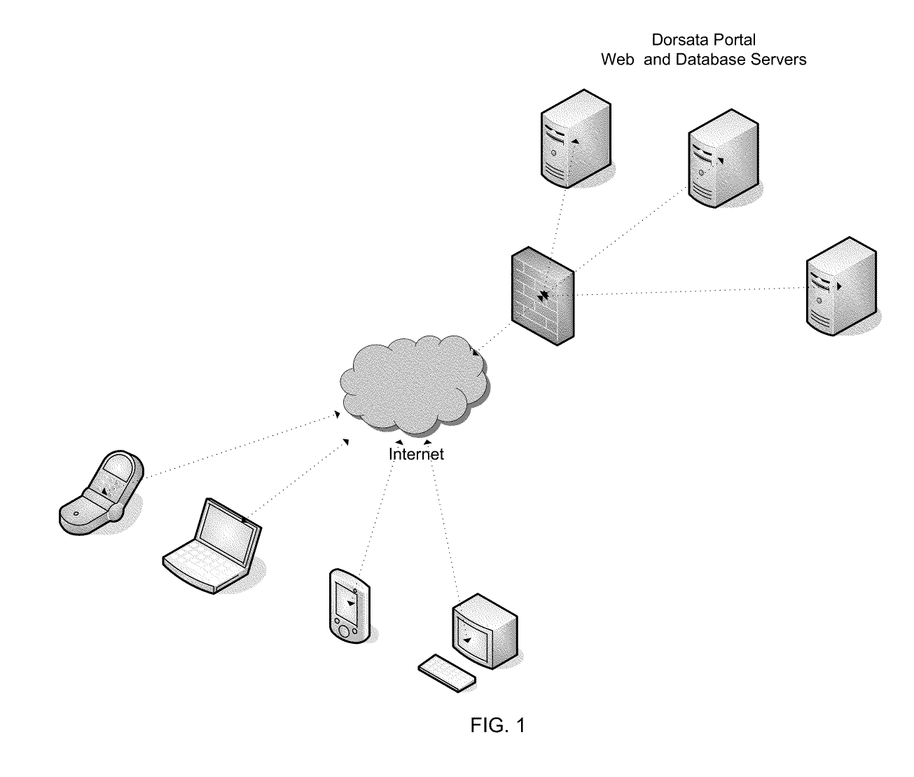

### DETAILED DESCRIPTION OF THE INVENTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

As used herein, a database may be a relational database, flat file database, relational database management system, object database management system, operational database, data warehouse, hyper media database, post-relational database, hybrid database models, RDF database, key value database, XML database, XML store, text file, flat file or other type of database.

As used herein, a workflow broadly refers to a path and/or order of steps in which the Collaborative Clinical Pathway platform may perform a task or a step. The order or number of steps may vary in different embodiments.

As used herein, a computer shall include without limitation desktop computers, notebook computers, netbook computers, personal digital assistants (PDAs), mobile phones, servers, handheld computers, cellular phones, and similar devices, including without limitation web enabled devices.

In some embodiments, the Collaborative Clinical Pathway platform may be implemented via one or more computers and a web browser 100. Each computer may be well known to those skilled in the art and may include a display, a central processor, a system memory, and a system bus that couples various system components including the system memory to the central processor unit. The system bus may be any of several types of bus structures including a memory bus or memory controller, a peripheral bus, and a local bus using any of a variety of bus architectures. The structure of system memory may be well known to those skilled in the art and may include a basic input/output system (BIOS) stored in a read only memory (ROM) and one or more program modules such as operating systems, application programs and program data stored in random access memory (RAM). The computers may also include a variety of interface units and drives for reading and writing data and a database for storing data. The computers may run an Operating System (OS). The OS may include a shell, for providing transparent user access to resources such as application programs. The OS may include a kernel, which provides essential services required by other parts of OS and application programs. The services provided by the kernel include memory management, process and task management, disk management, and I/O device management. The OS may be the Linux Operating system, Microsoft Operating system or other operating systems.

Each computer may be able to communicate with another computer via a network using a network interface, which is coupled to the system bus. The network may be an external network such as the Internet, or an internal network such as an Ethernet or a Virtual Private Network (VPN). The network may also include one or more of a wireless network, a wired network, the Internet, a PSTN, a private network, or any other communication network. The computers that implement the Platform may be implemented on a variety of hardware platforms or implemented in a variety of software environments.

Applications running on or accessing these computers may include a browser 100, a rules engine, a workflow application or other application required by the Platform. A browser 100 may include program modules and instructions for enabling a World Wide Web (WWW) client to send and receive network messages to the Internet. The browser 100 may use well known protocols, such as Hypertext Transfer Protocol (HTTP) messaging to enable communication with another computer.

### Creating a Pathway

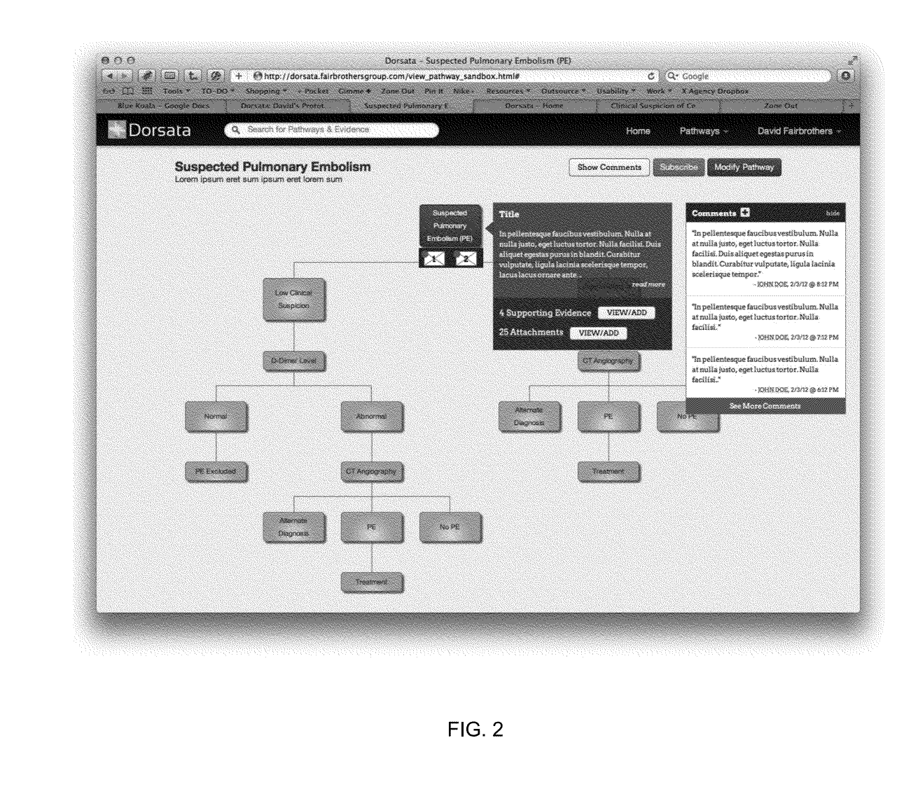

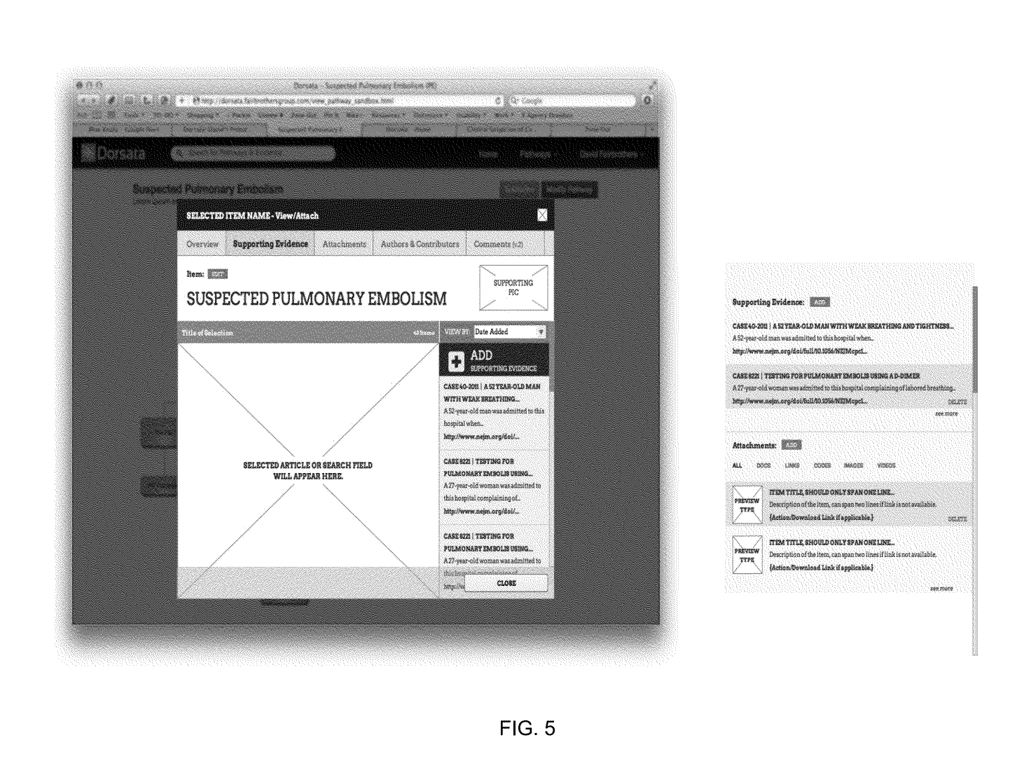

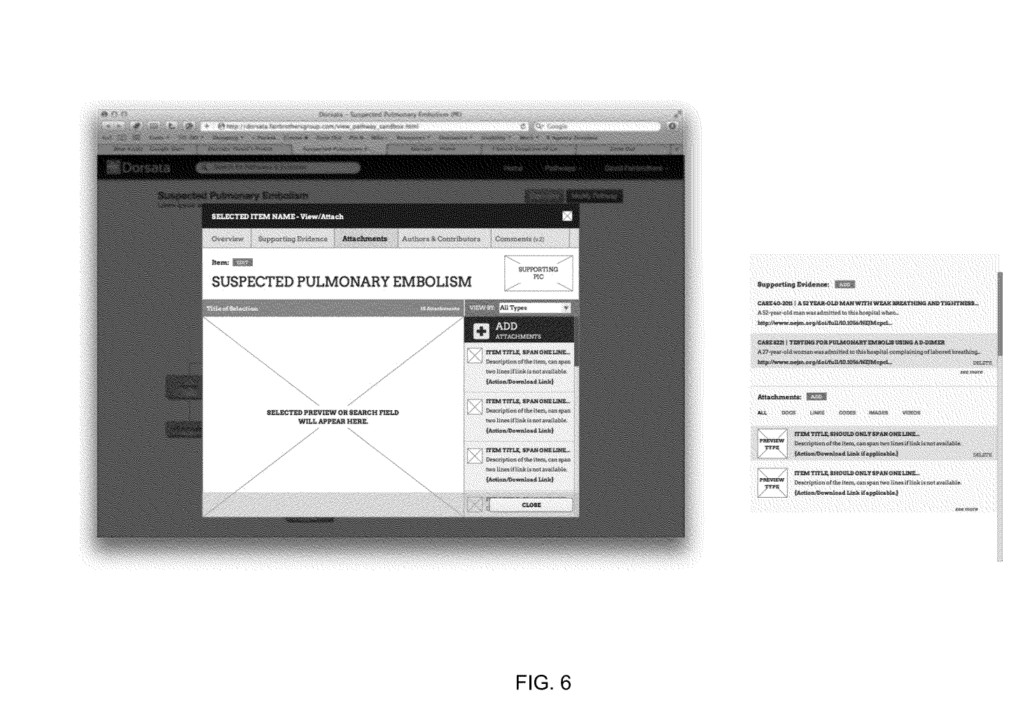

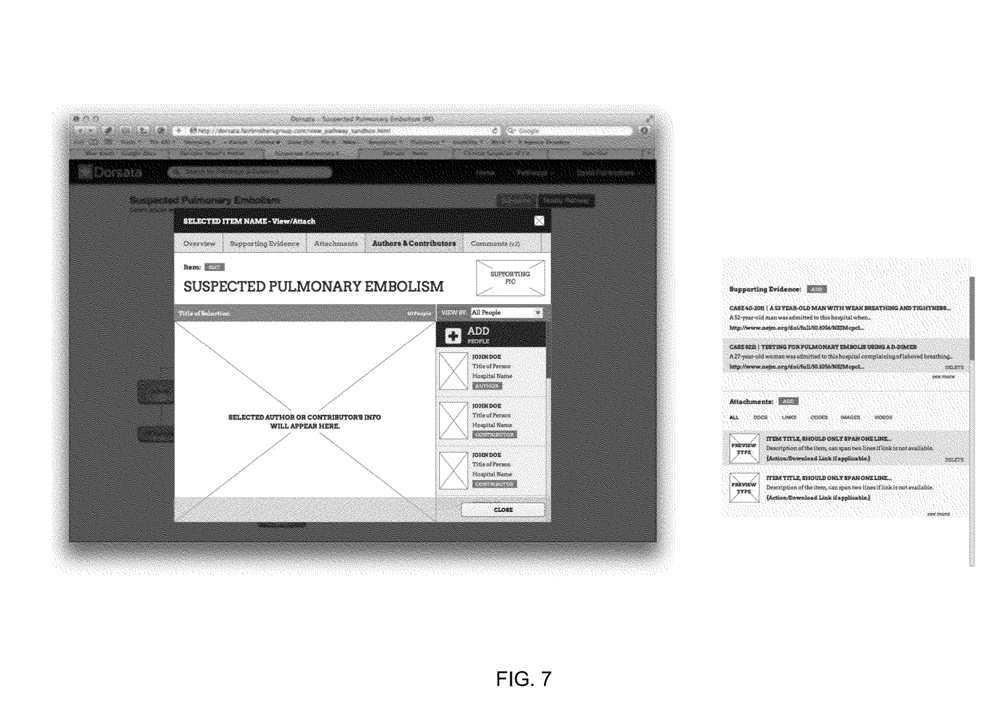

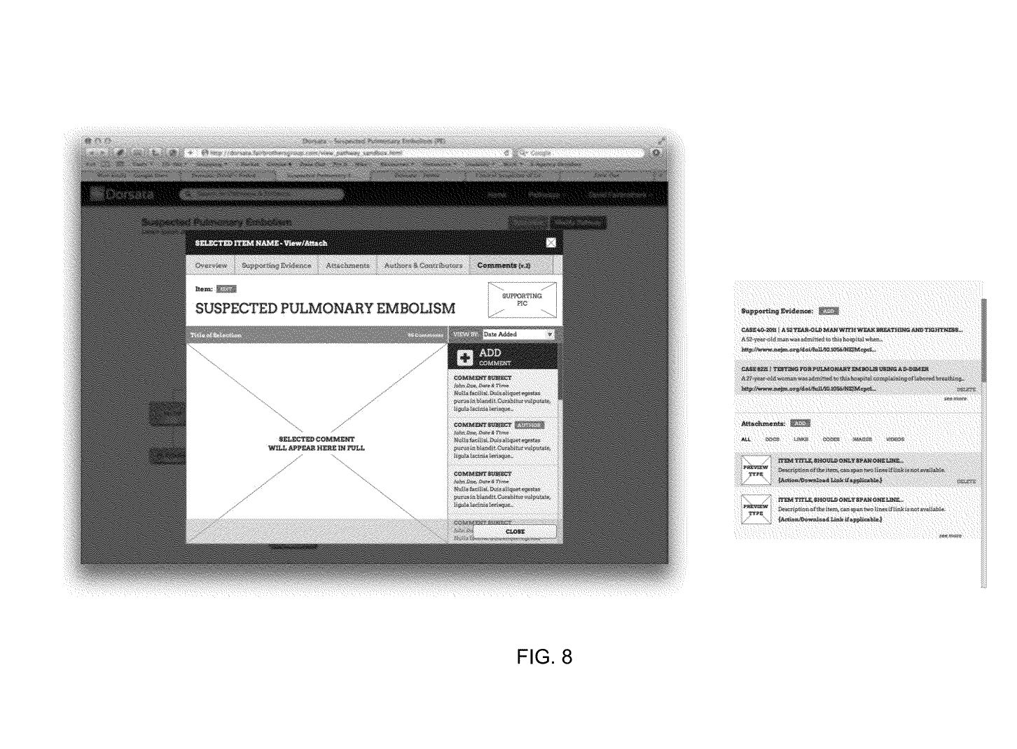

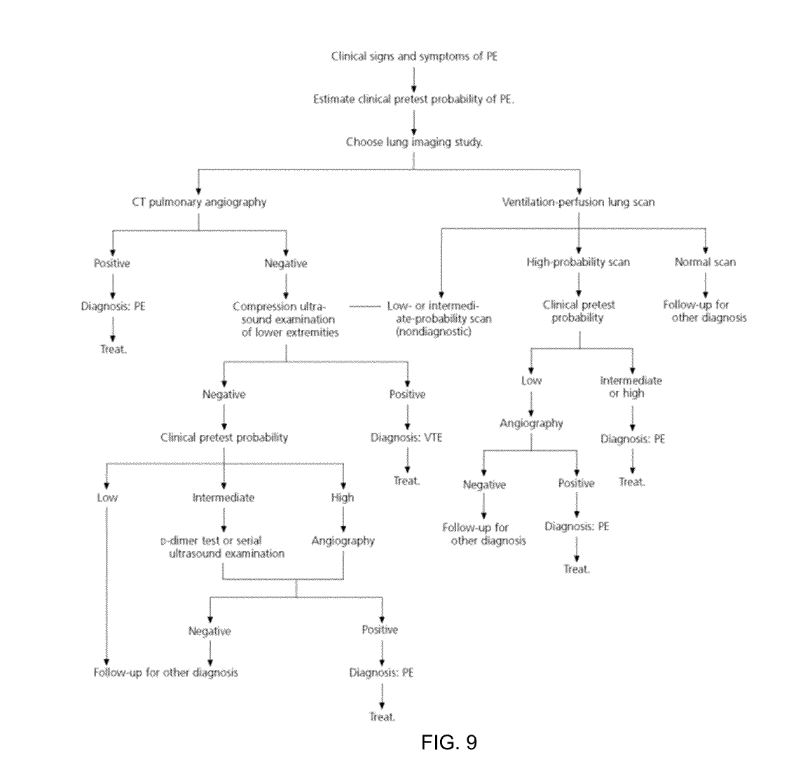

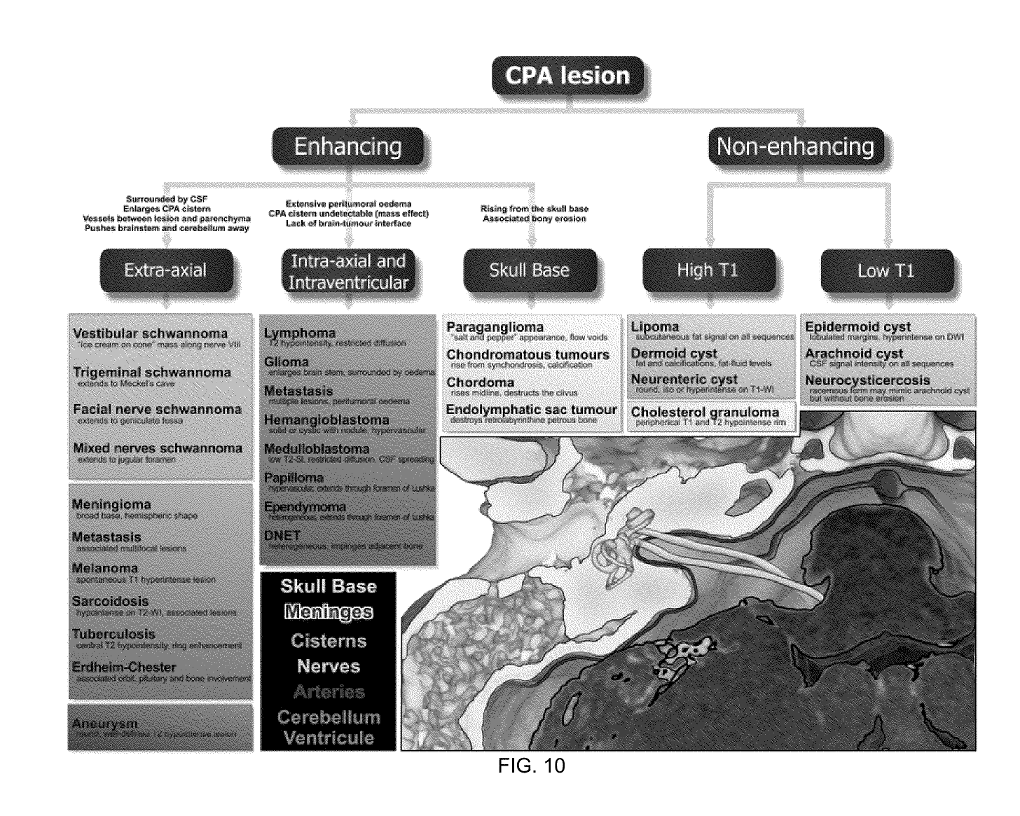

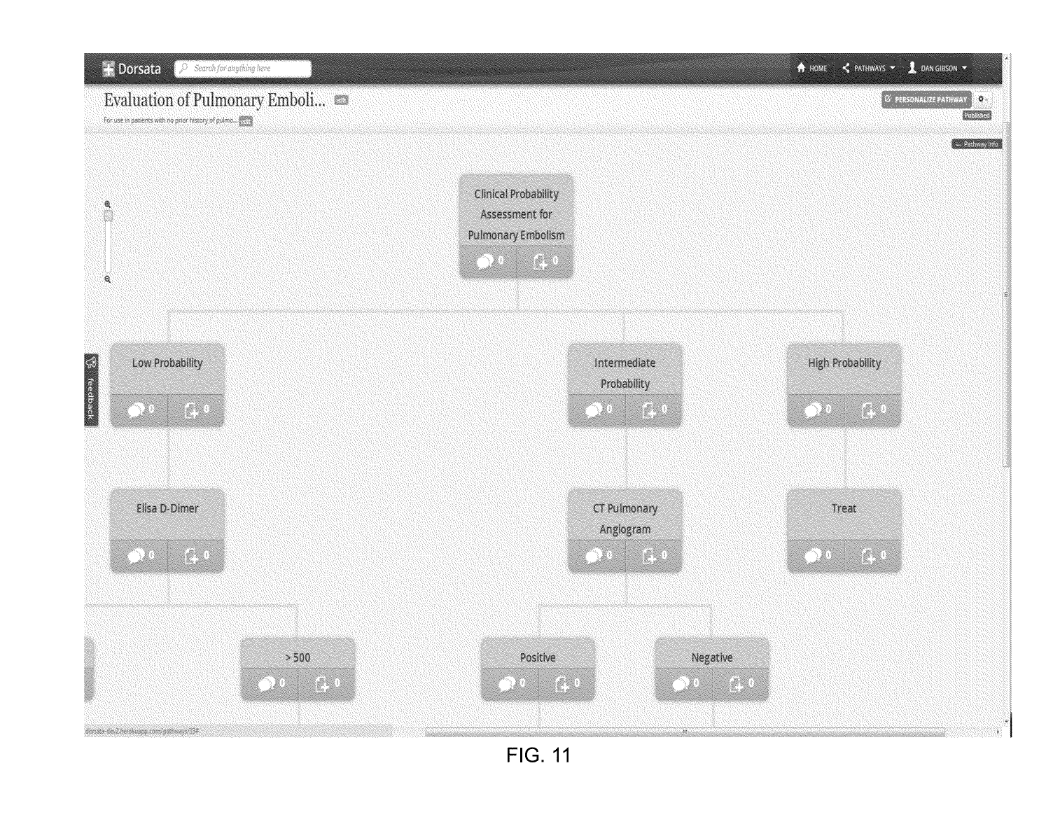

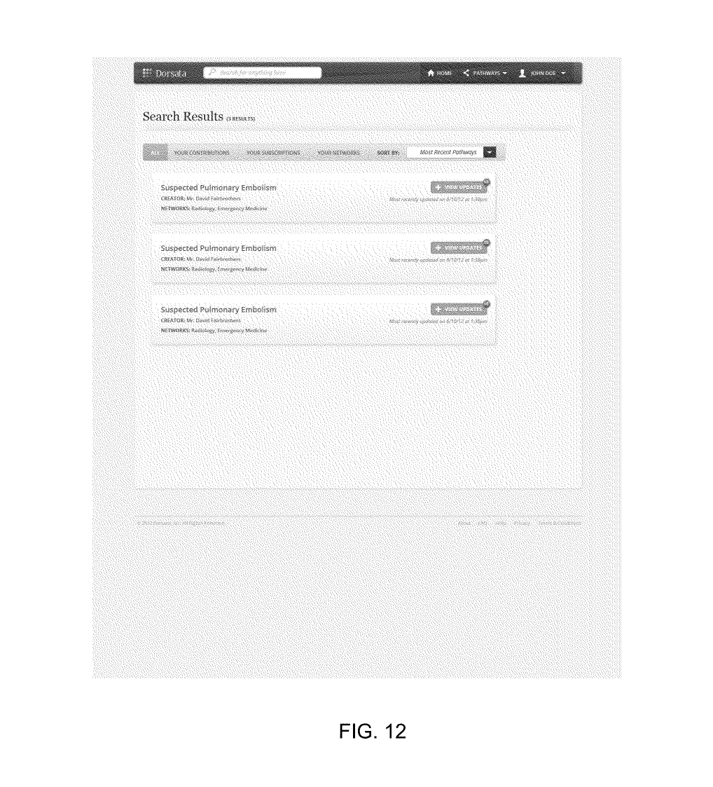

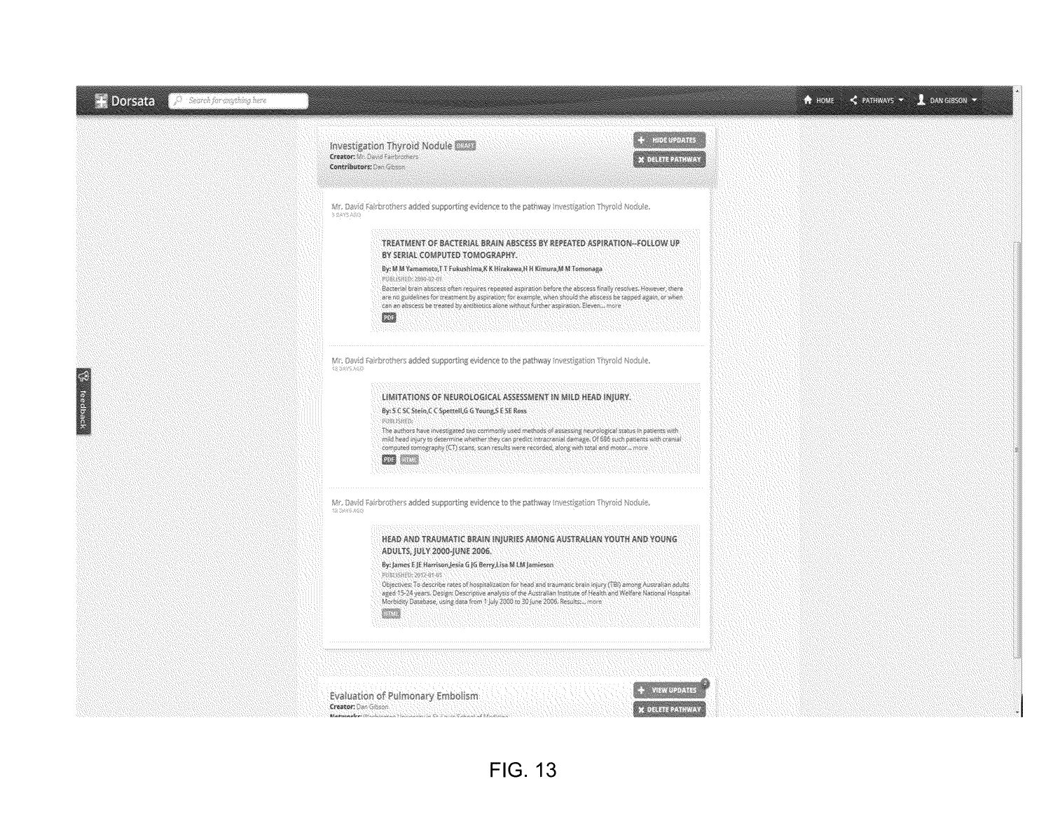

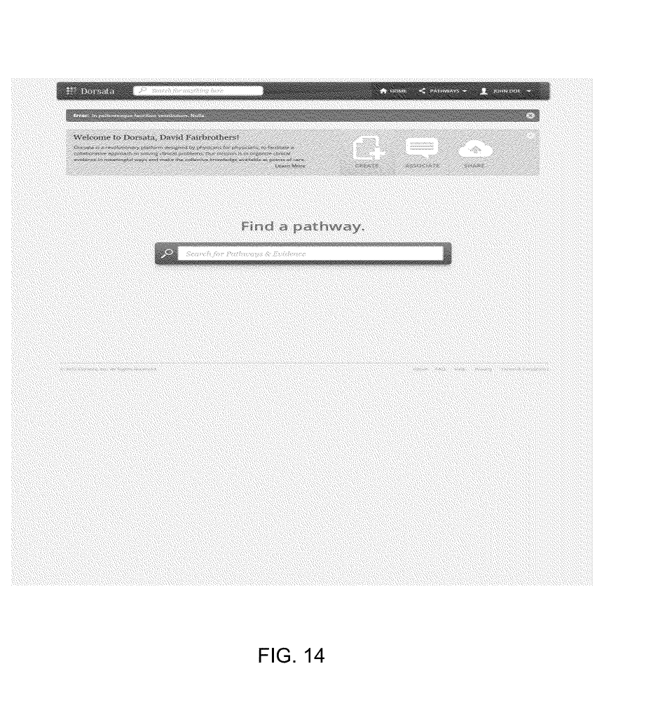

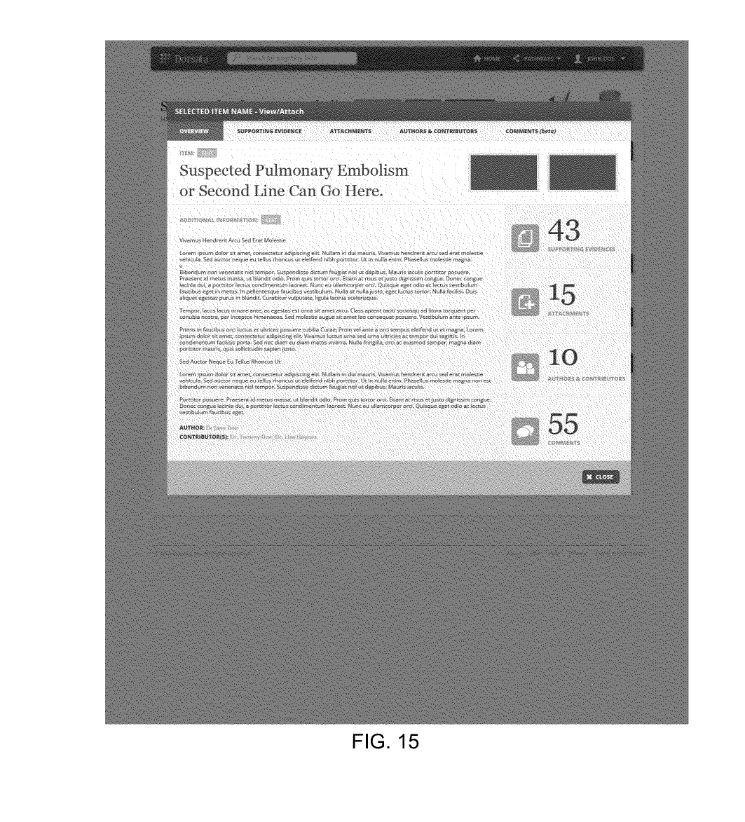

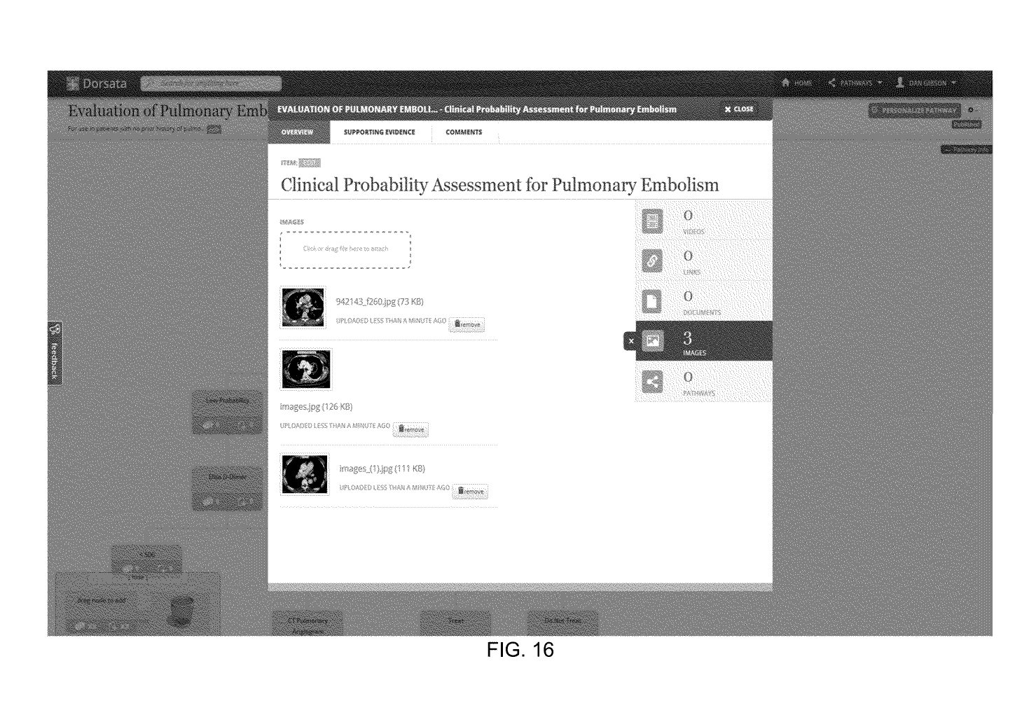

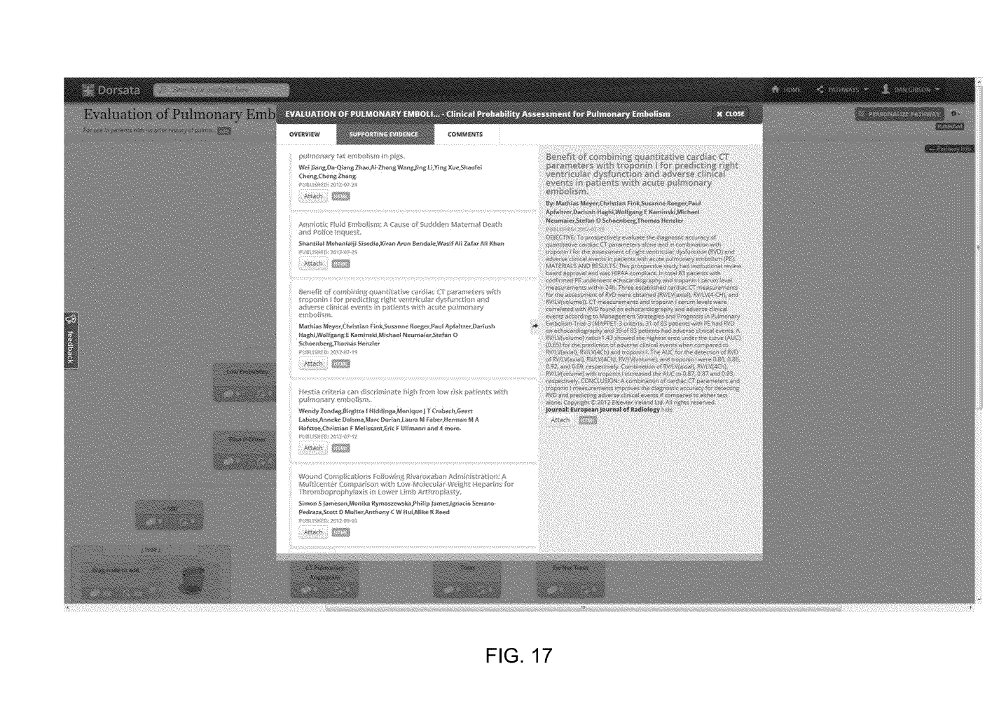

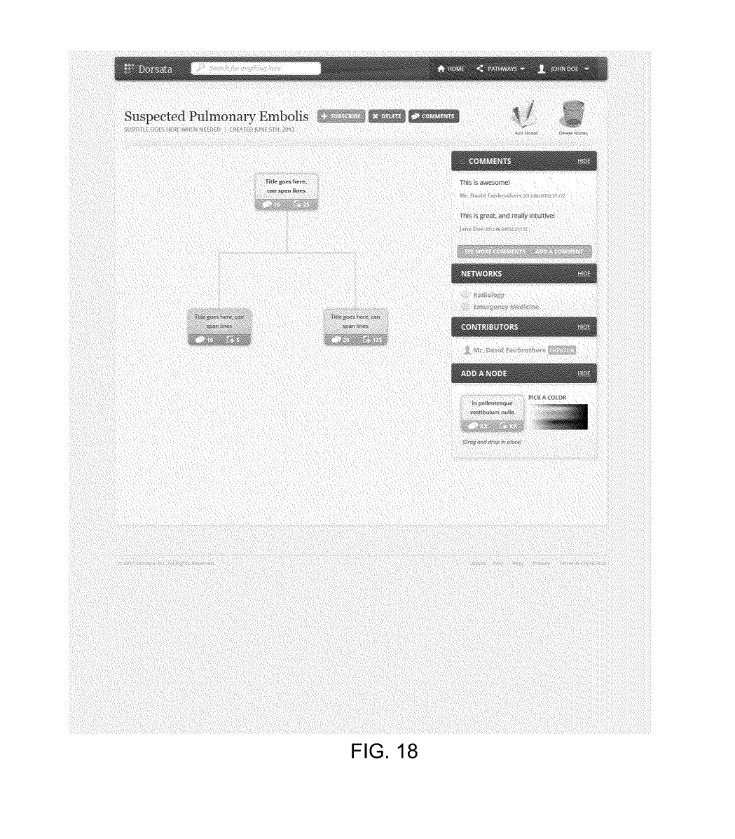

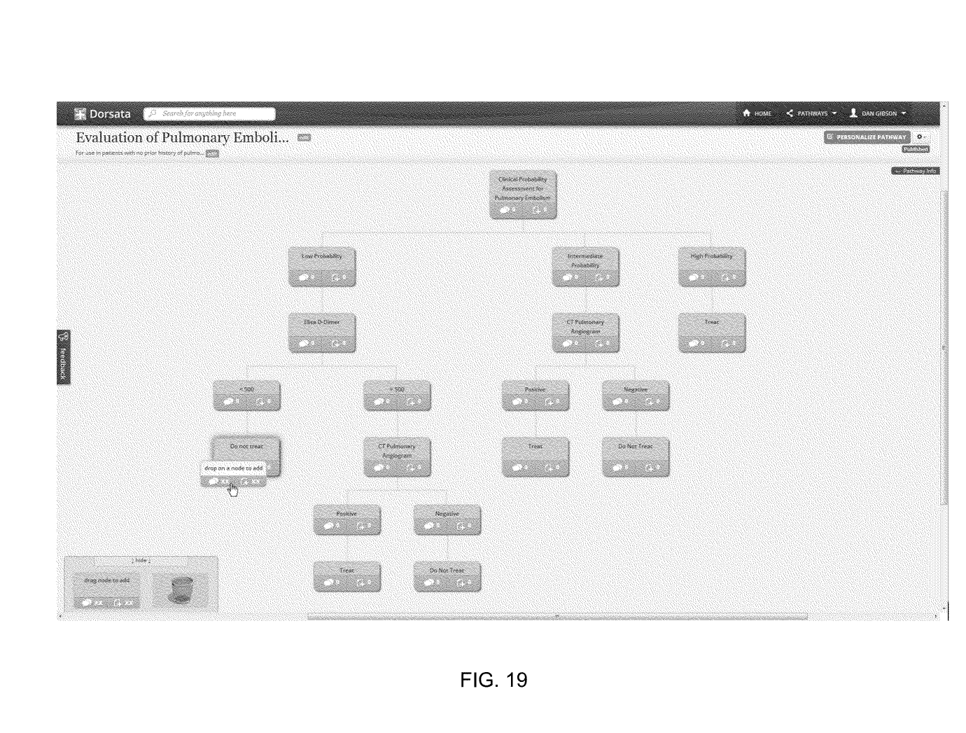

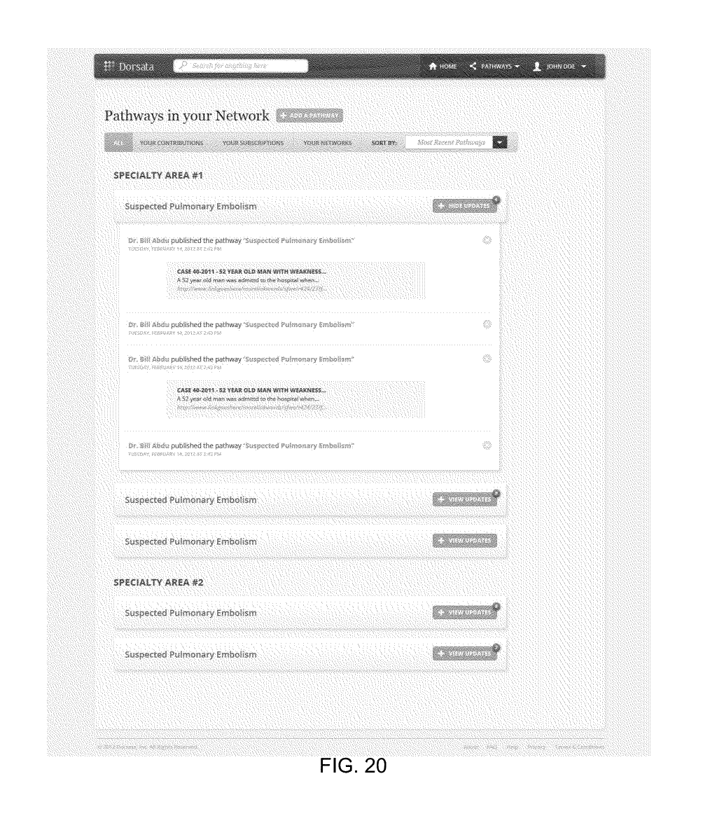

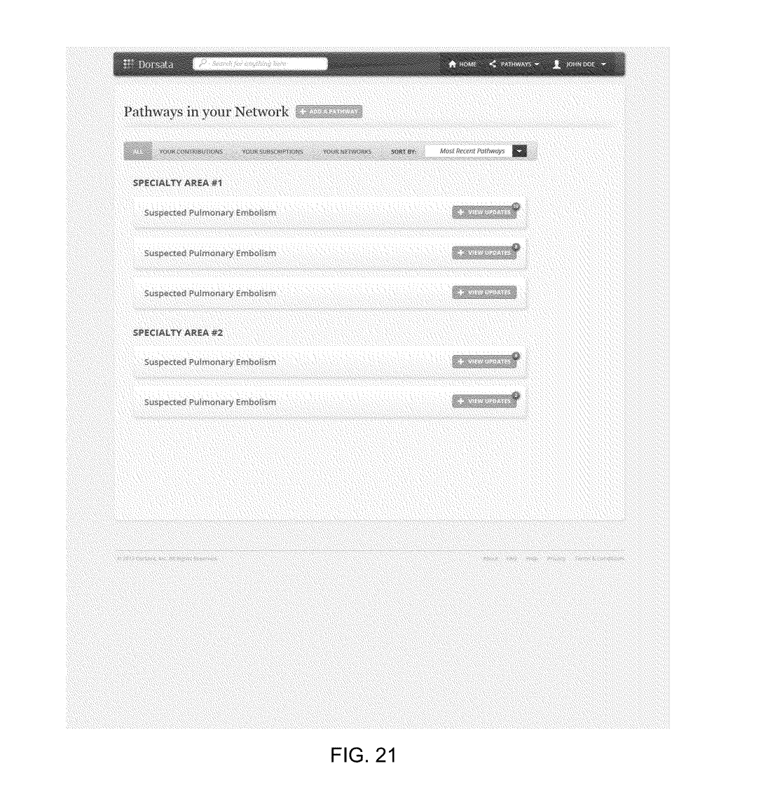

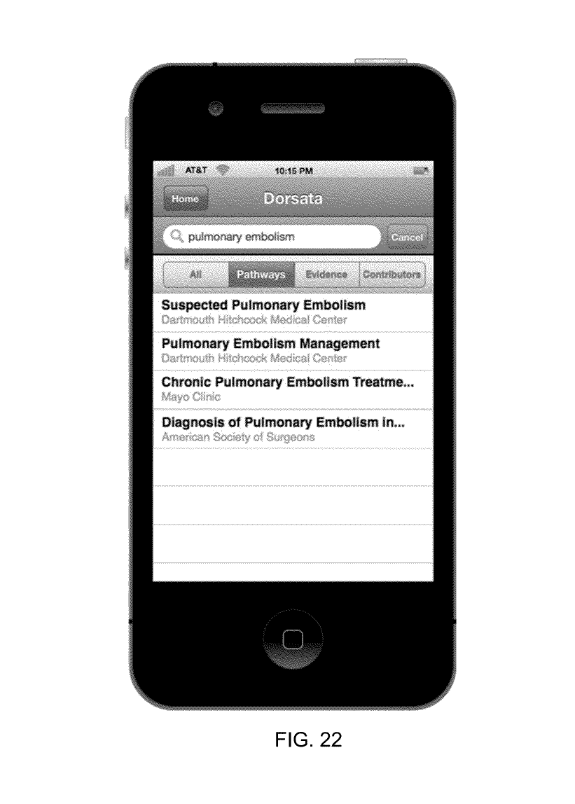

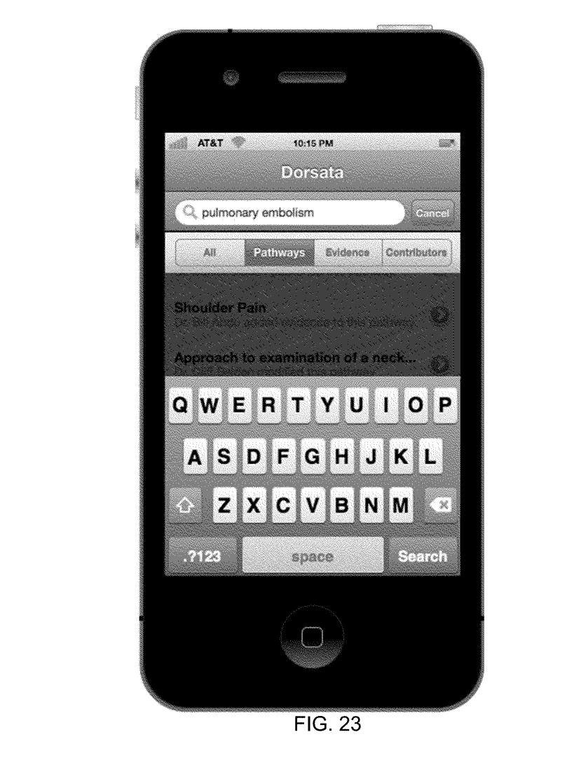

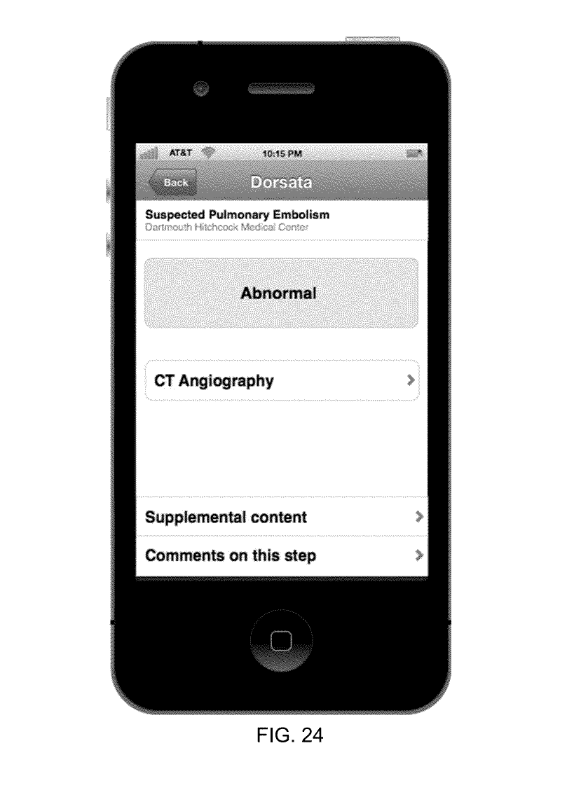

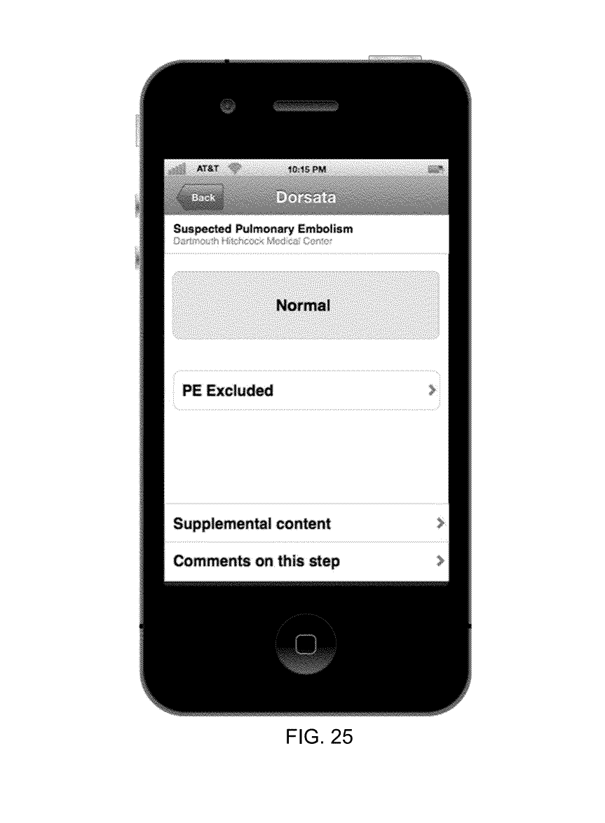

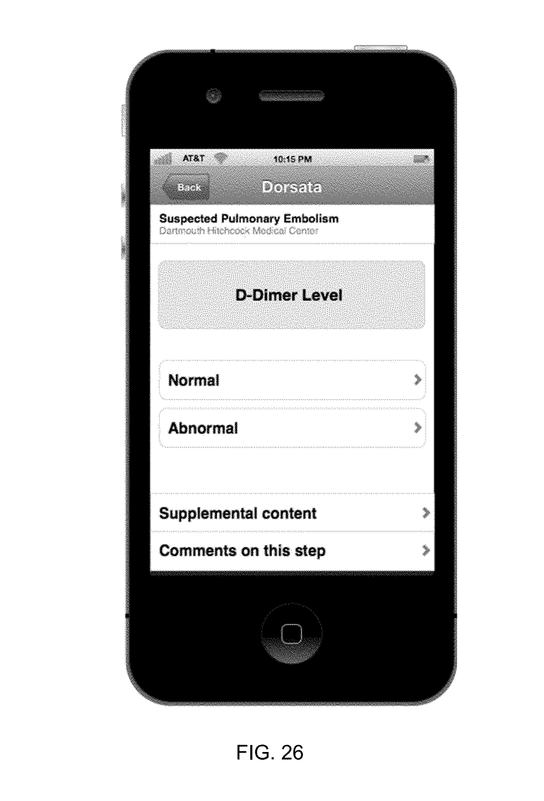

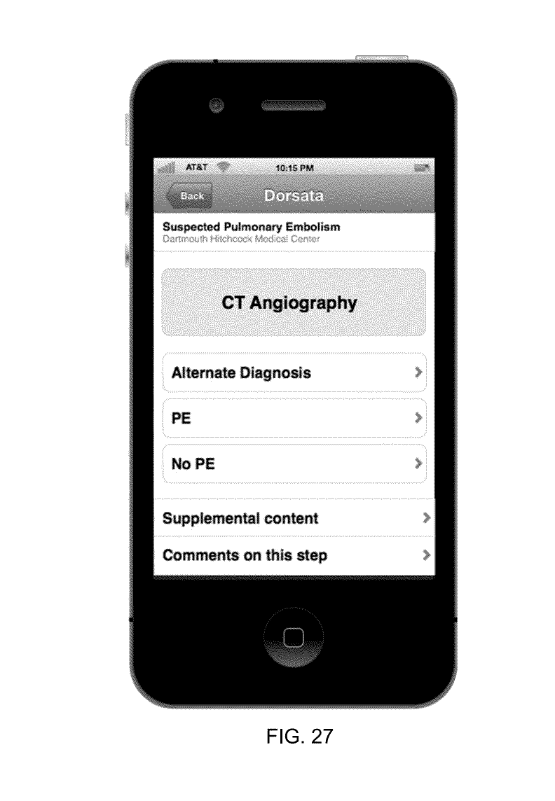

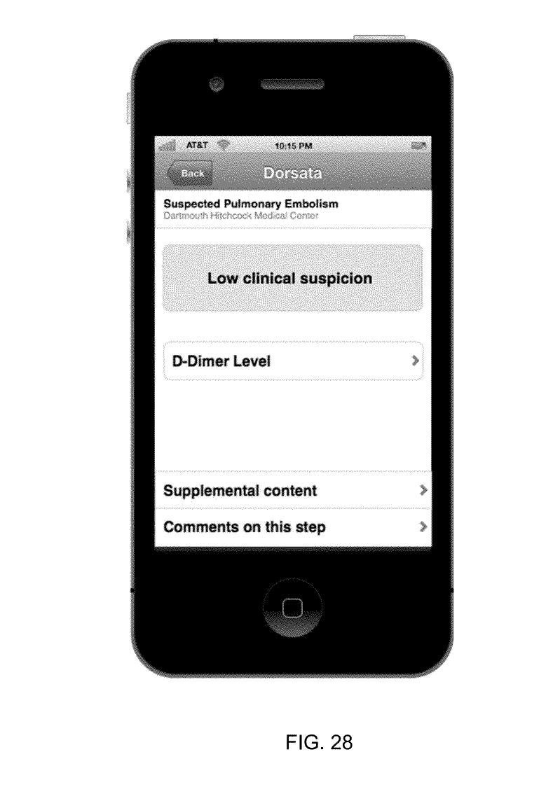

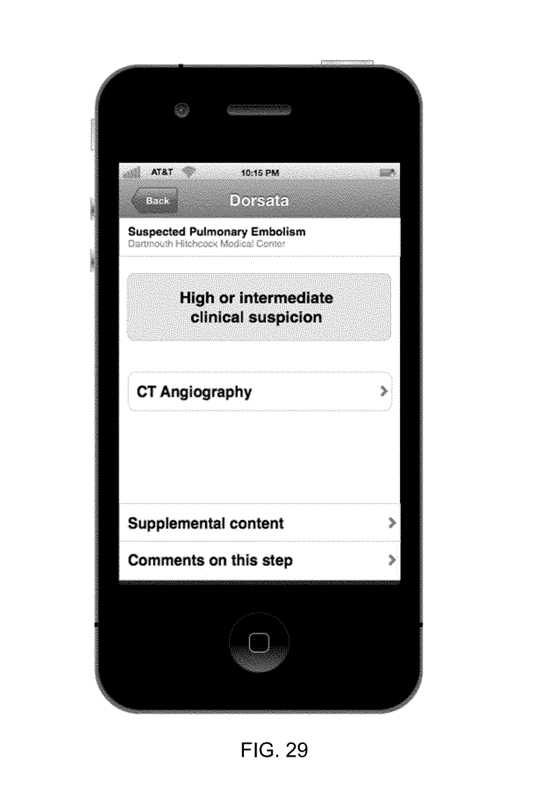

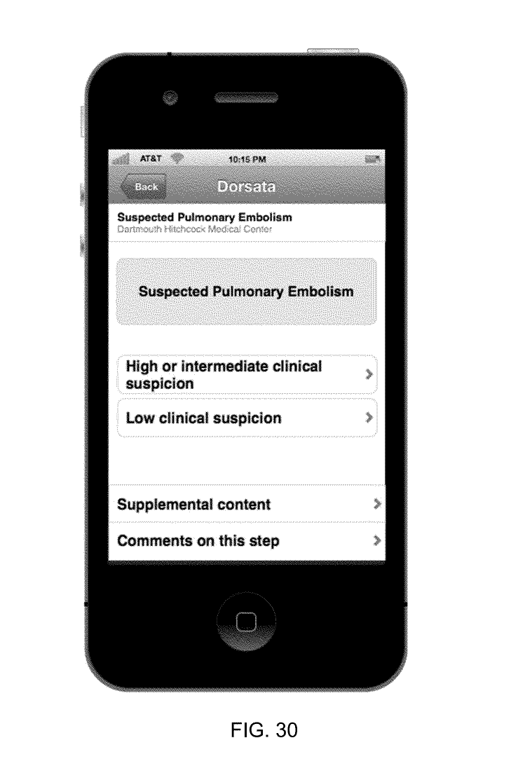

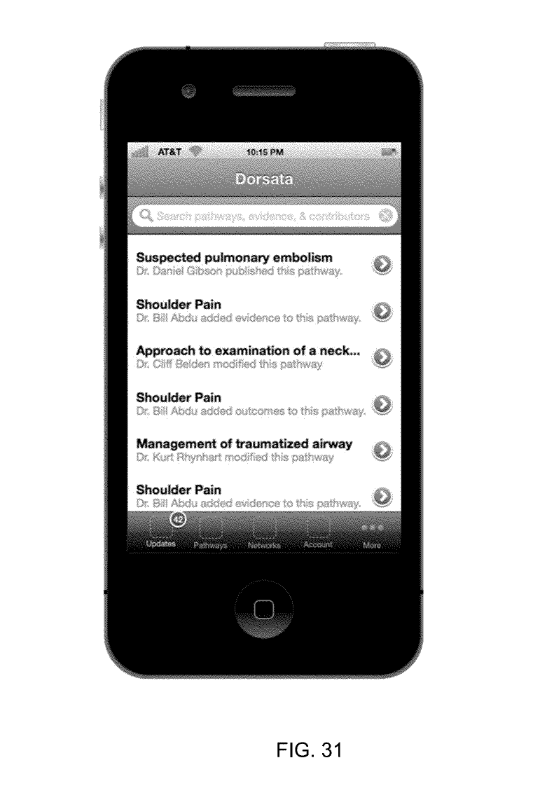

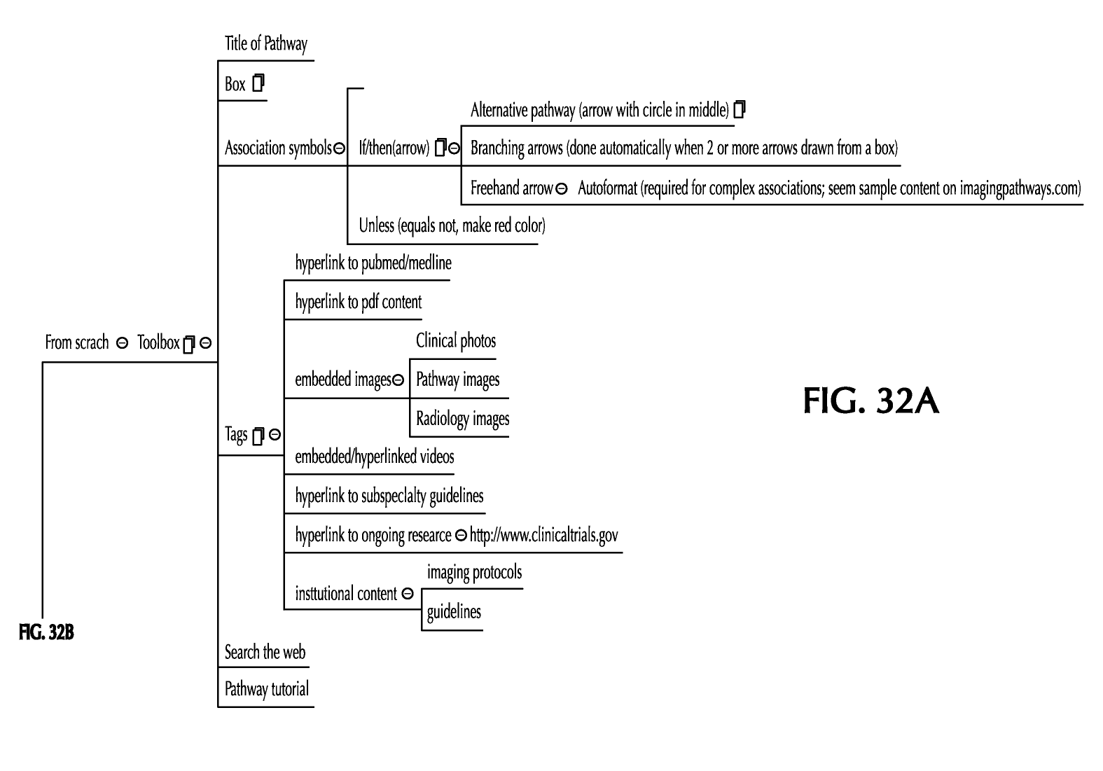

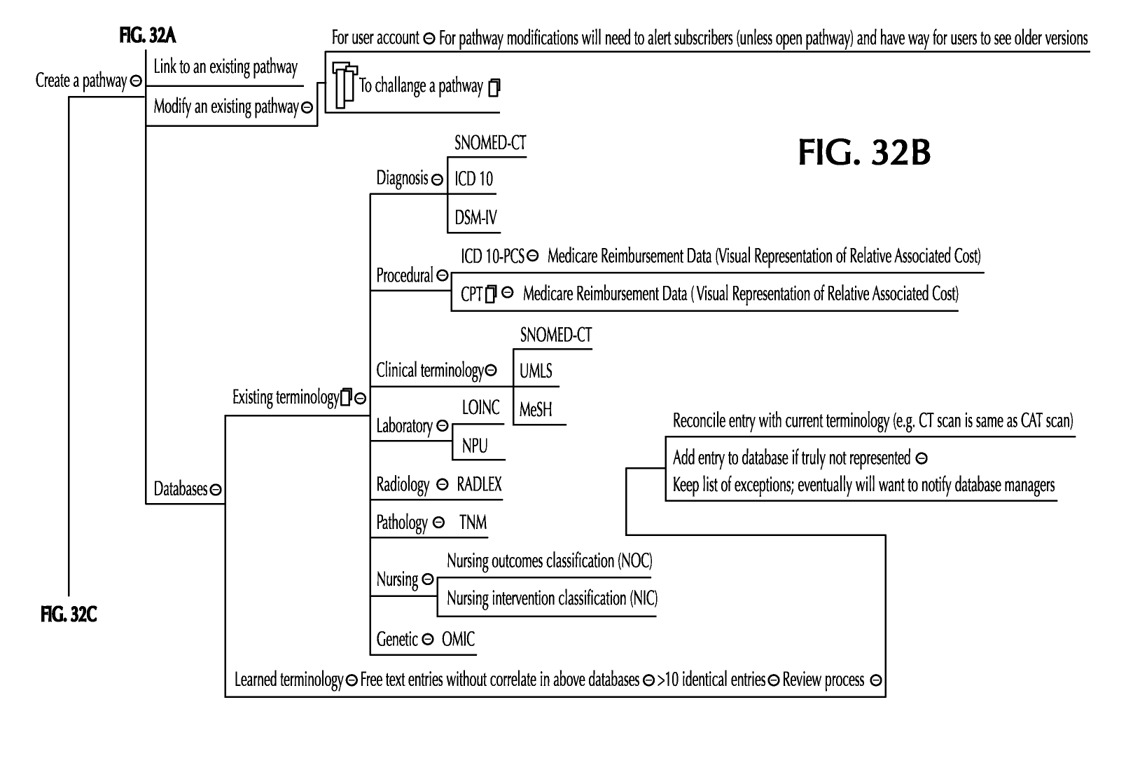

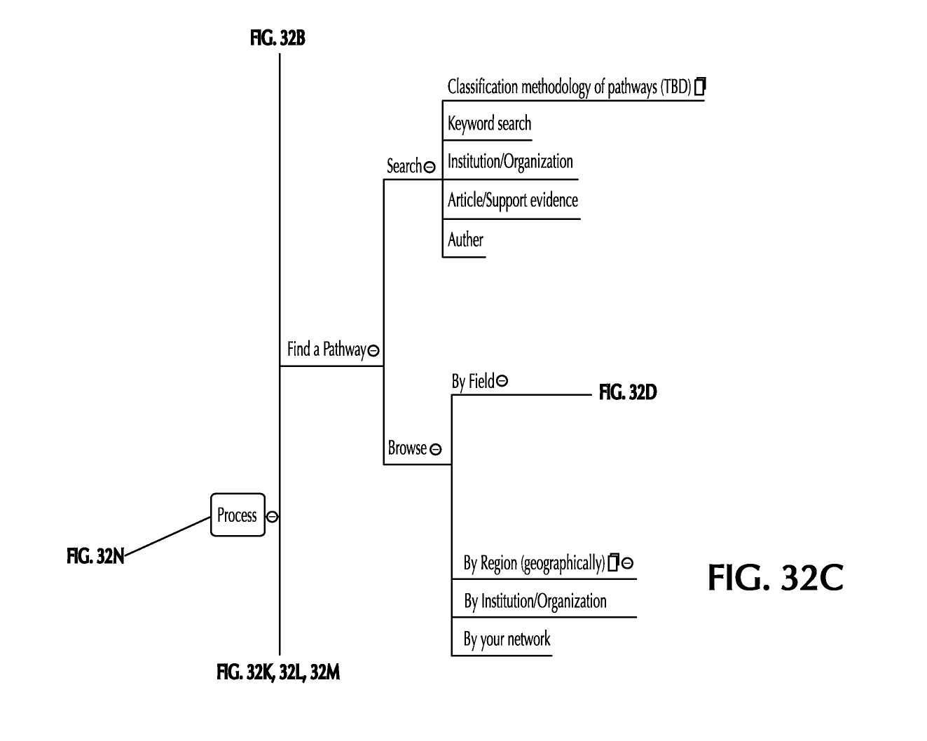

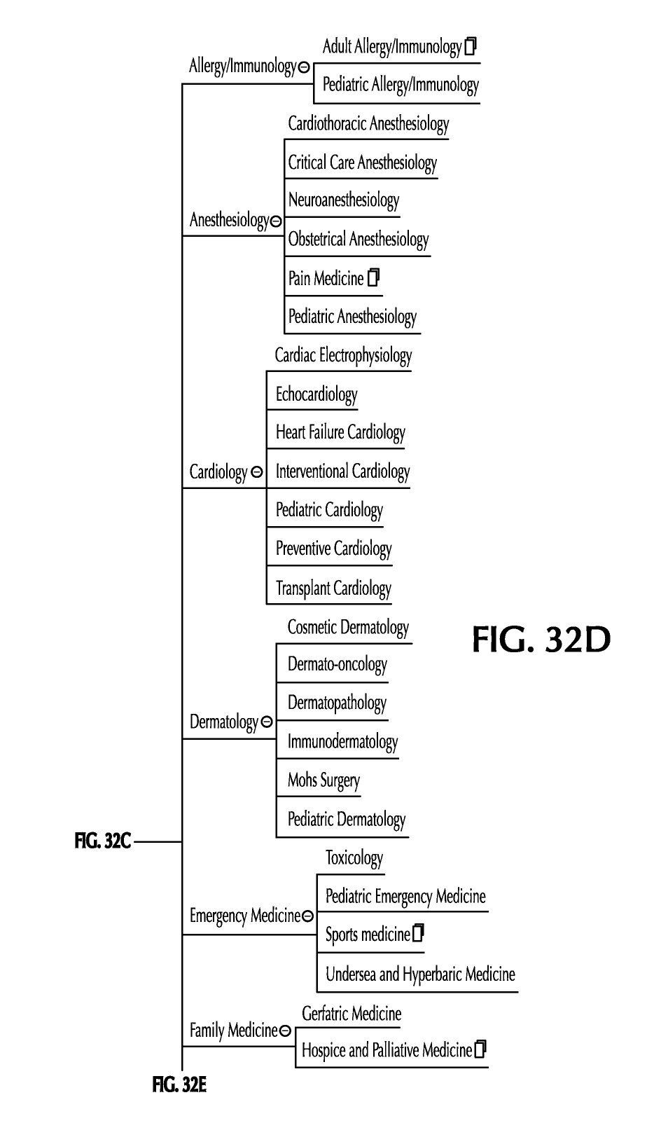

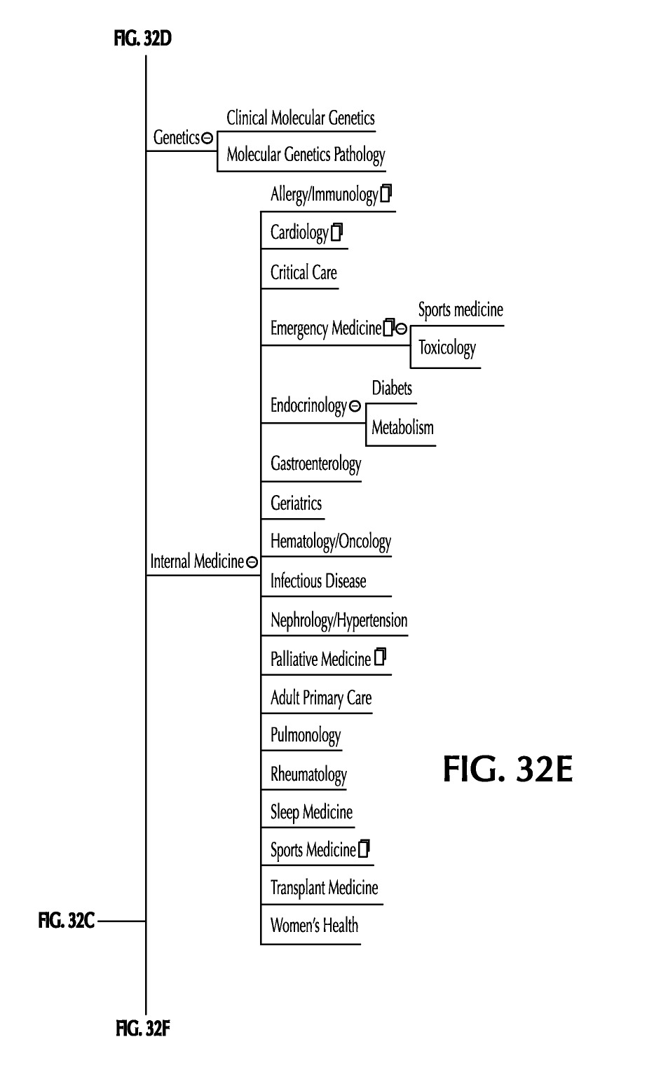

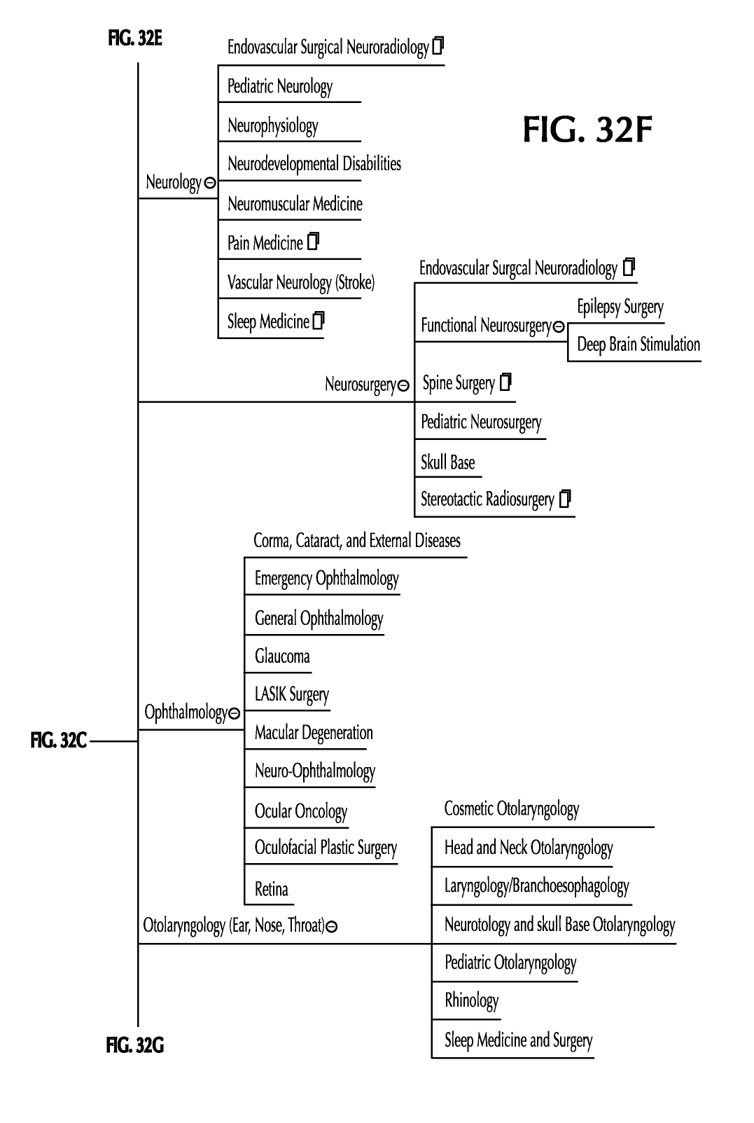

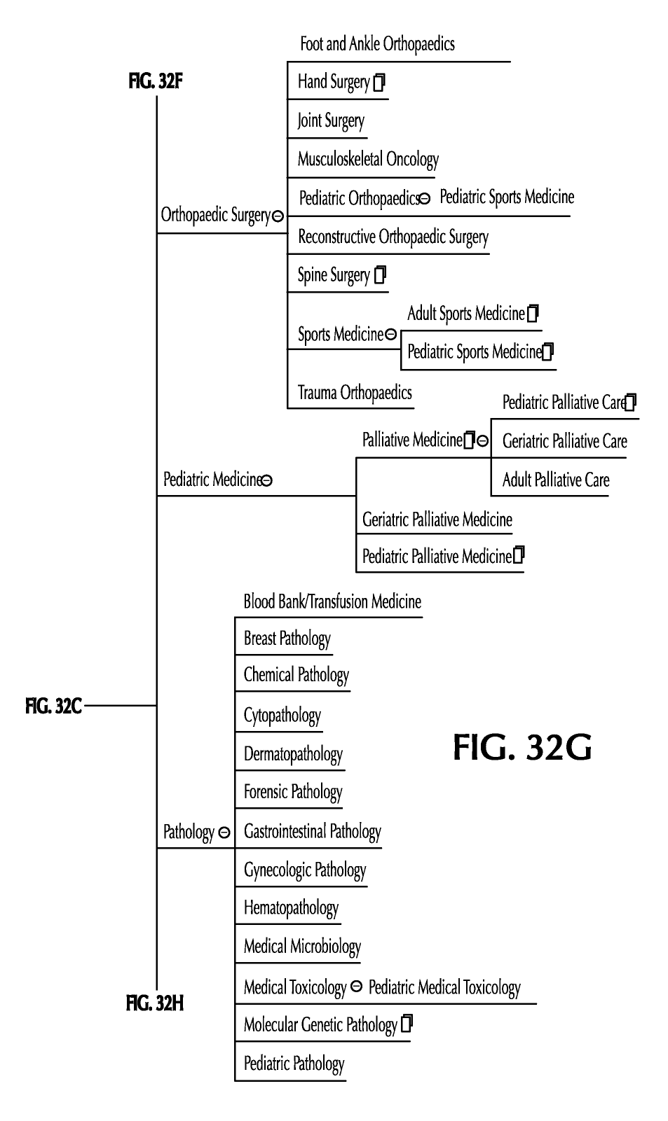

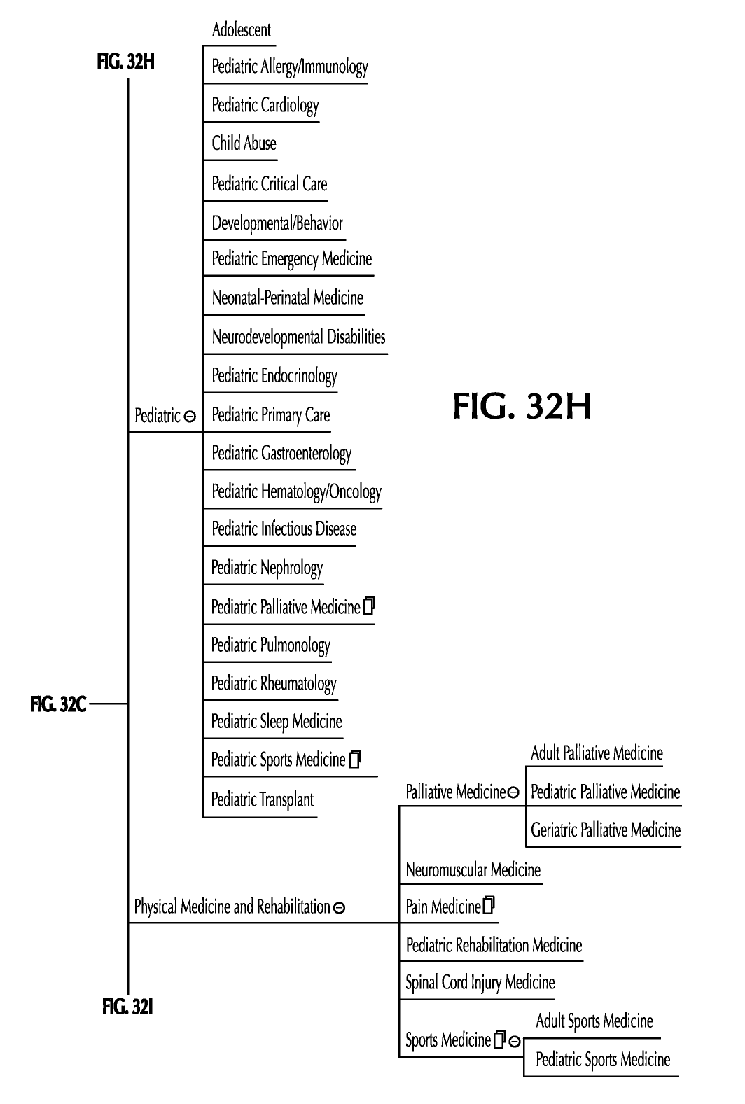

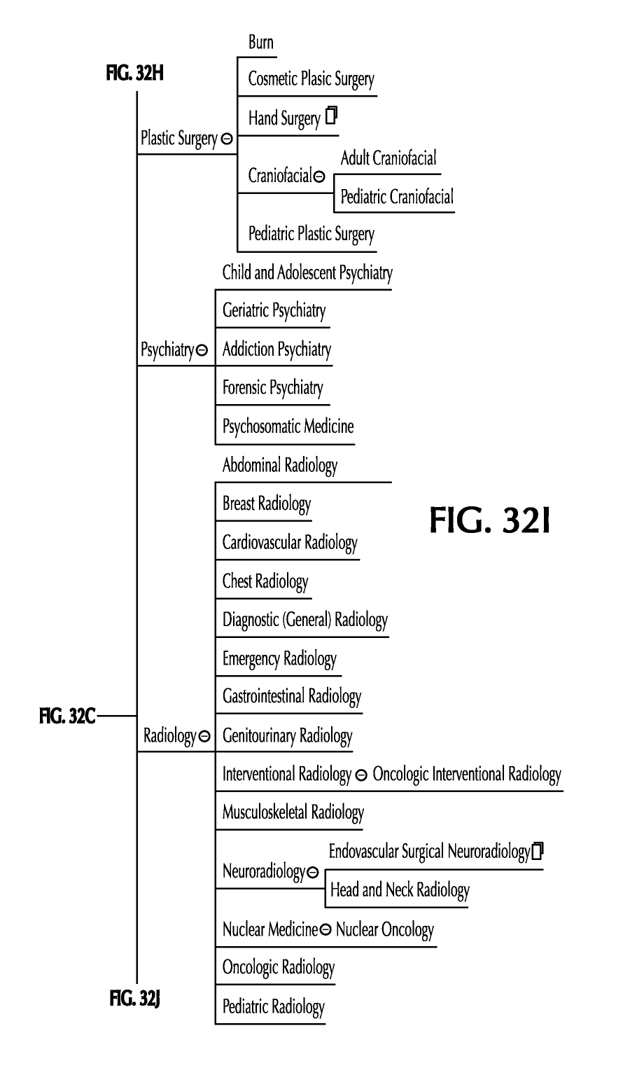

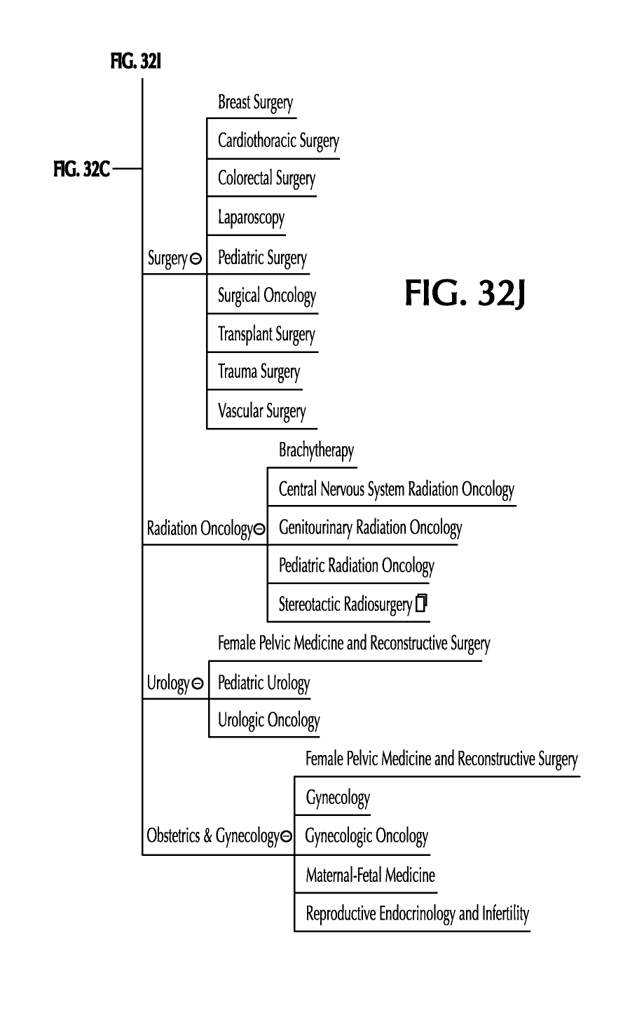

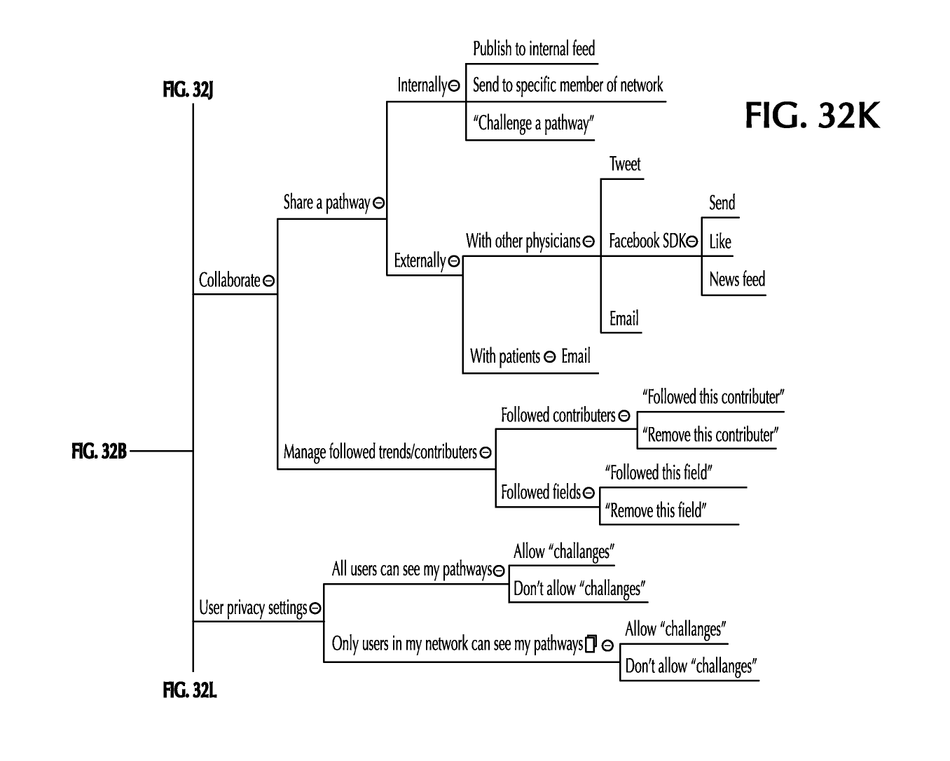

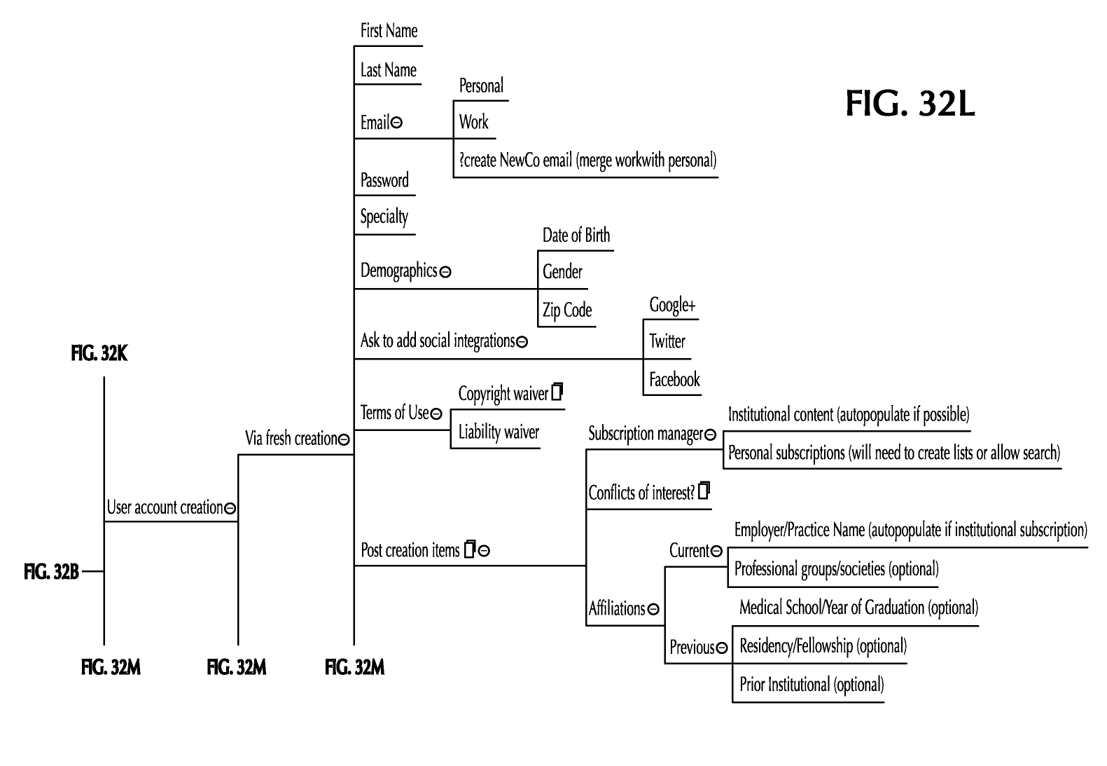

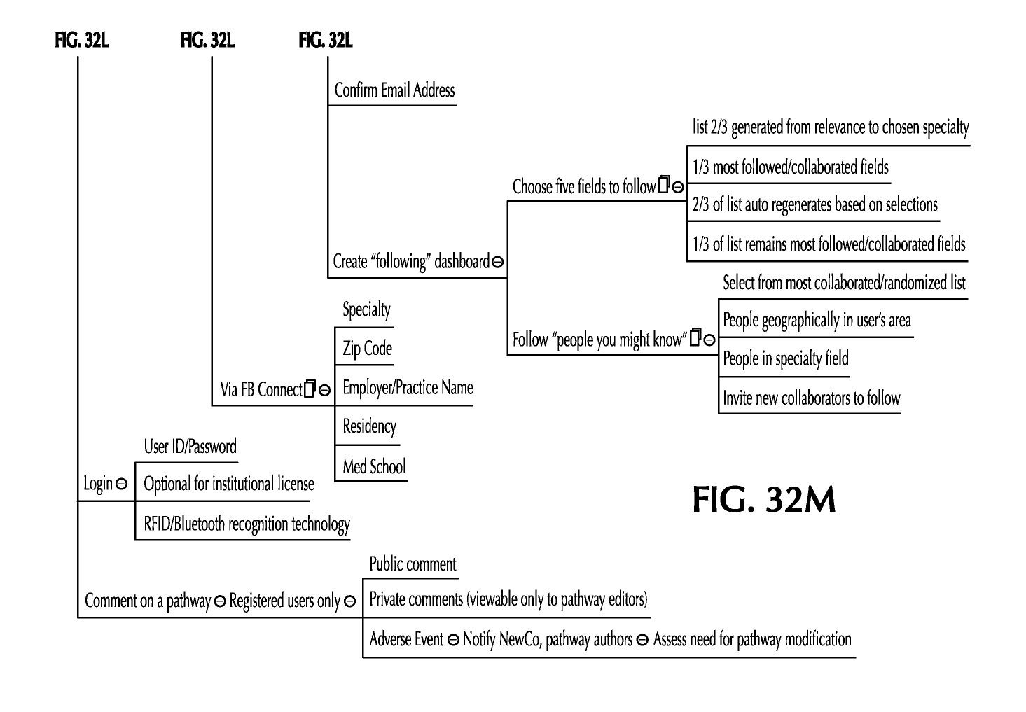

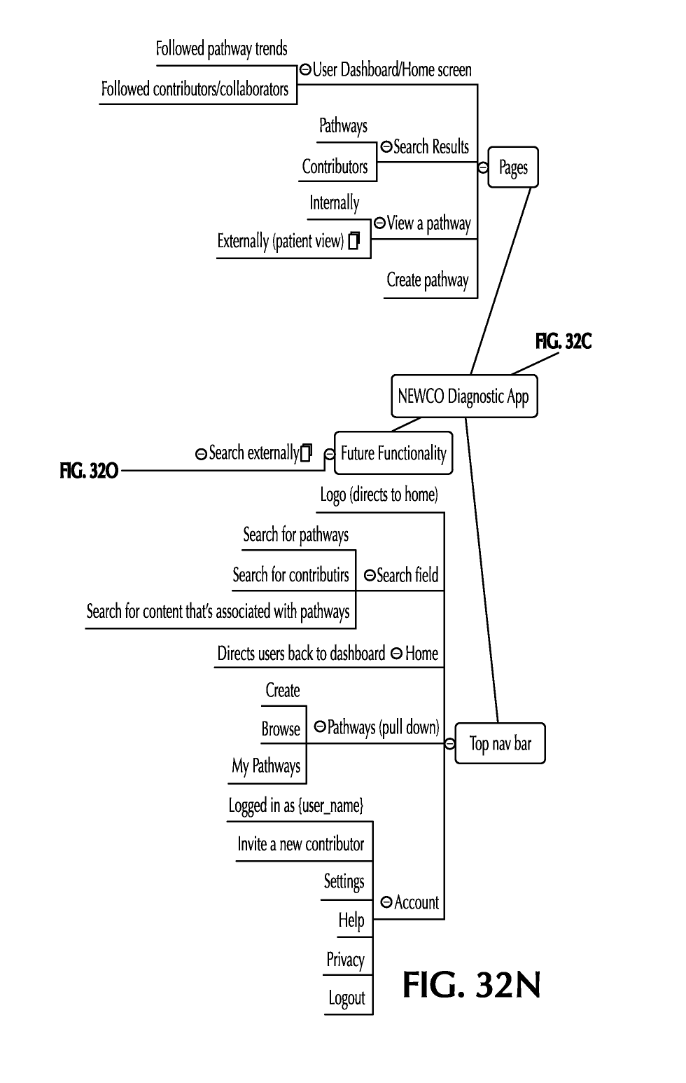

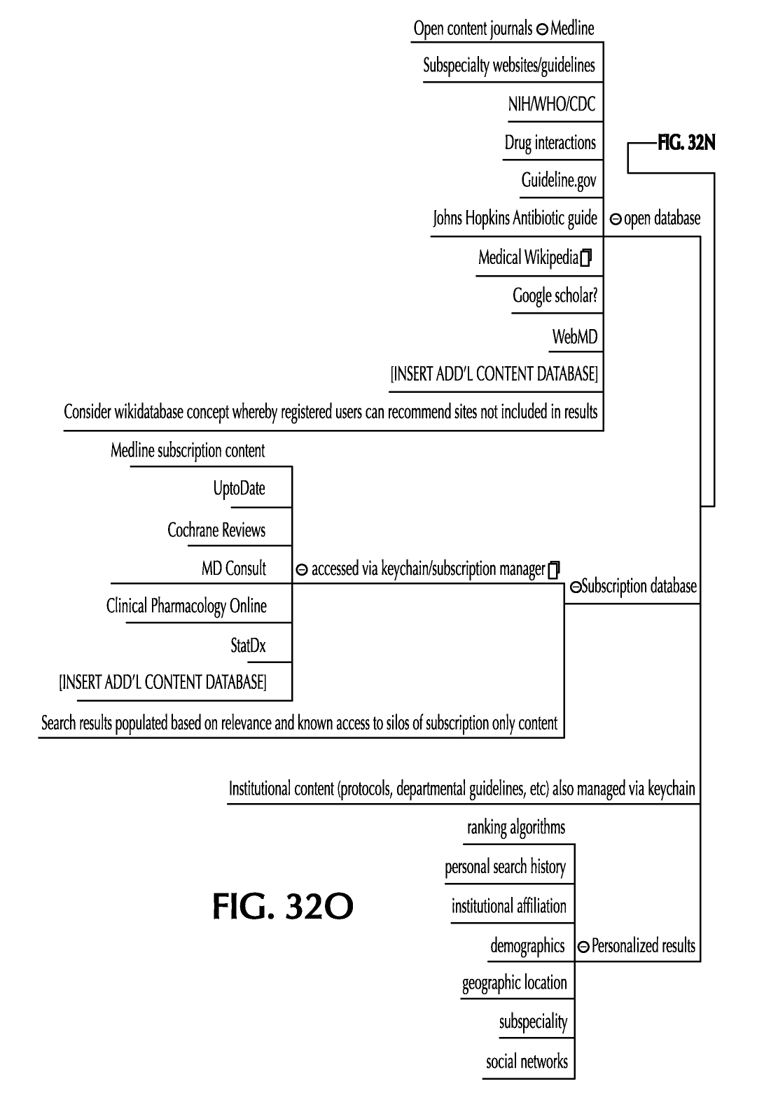

Embodiments of the present invention provide an improved Platform for clinicians and others to collaborate in the building of decision-making algorithms or creation, use or management of collaborative clinical pathways. In some alternatives, the Platform may provide users with the ability to use “Drag and Drop” techniques as illustrated in FIGS. 2-8 and 11-22 for the development or modification of clinical pathways.

The Platform may include components for the creation and consumption of graphical pathways with underlying databases. The creation and discovery of pathways may occur in a centralized or decentralized, web-based platform and database. Pathways may be developed through a graphical, drag-and-drop interface, allowing the user to see a visual representation of the underlying relational data records. For example, a user may add one or more graphical nodes to a clinical pathway by dragging and dropping a new graphical node from a toolbox within the Platform into a designated target area. In some alternatives, the user may be able to create a relational data record between nodes by dragging and dropping a new node into the target area of an existing node. The relational data record created by this action may establish a parent to child relationship between nodes, the existing node may be the parent node and the new node may be the child node. In some alternatives, a user may be able to edit textual content of a node through the Platform's GUI. The edited textual content may be stored as an object in the Platform's database. In some alternatives, the textual content for a node may be retrieved using live search technology to query a database of clinical terms and their variants, while the user is typing the textual context. In some alternatives, the textual content may include a selected variant and one or more clinical diagnosis codes. In some alternatives, the Platform may recommend appropriate textual content and/or clinical term variants to a user based on similarities in the intra node relational data in a database. For example, the Platform may compare similar nodes from one or more pathways to assist the user with recommending similar relationships for the current node that a user may edit. In some alternatives, the user may locate pertinent evidence to support the textual content. This pertinent evidence may be stored as a relational record to the textual content.

In some alternatives, the underlying relational databases may contain records associating specific nodes within pathways, establishing parent to child relationships. These intra pathway relationships may be used to process semantic search queries by users to deliver targeted and relevant search results. For example, the Platform may be able to deliver user specific pathways which contain the node to node relationship “headache+fever”. Pathway nodes may have associated content such as images, videos, external links, cited evidence, published journal articles, related guidelines from subspecialty societies or governments, user comments, institutional protocols, coding terminology (e.g., ICD-11, SNOMED, CPT), and links to additional pathways which reside in the Platform's database.

### Finding a Pathway

The Platform may allow for users to search for specific pathways using semantic keywords and strings and be presented with relevant and accurate search results. In some alternatives, the search results may be ranked and organized via a method of user feedback. For each observed user interaction with a given pathway search result page, the Platform may promote the position of a result the user may have interacted with during subsequent searches by other users. Over time, this implicit feedback loop may provide more accuracy in the search results. In some alternatives, the search results may be ranked and organized based on data collected from previous Platform queries, both by a specific user or by other users of the Platform. In some alternatives, the search results may be ranked and organized based on data derived from the association of the user with networks available on the Platform. In some alternatives, the search results may be ranked and organized based on data derived from the user's subscriptions to pathways in the system. In some alternatives, the search results may be organized by the previous pathways which the user has navigated in the Platform. In some alternatives, the search results may be ranked in part by data collected from usage data by all Platform users, such as the number of times that a pathway may have been accessed by the Platform users; time the Platform users may have spent browsing a particular pathway; the number of Platform users that may be subscribed to a pathway; and the number of times the Platform users may have copied or personalized a pathway. In some alternatives, the search results may be ranked in part by explicit positive or negative user ratings. In some alternatives, the search results may be ranked by a sentiment analysis of user submitted comments. In some alternatives, the search results may be ranked in part by the number of time a pathway has been referenced by other pathways. In some alternatives, the search results may be ranked in part by the internal rankings of pathway contributors. The pathway contributors may be ranked by metrics, such as the number of pathways published on the Platform; the number of subscribers to those pathways; and the number of times a given contributor's pathway has been copied within the Platform. In some alternatives, the search results may be ranked in part by the number of nodes contained in a pathway. Pathways with a higher number of nodes, with a log based growth rate, in some cases may be ranked higher. In some alternatives, the search results may be ranked in part by an analysis of similarities between individual users. Similar users may be grouped based on explicit and implicit signals. Search results may be served on an individual basis according to the broader group's desires. In some alternatives, the search results may be ranked in part by historical user usage data from historical versions of pathways. As a pathway has changed over time, usage data may vary and may therefore provide insight as to how relevant a particular pathway may be at certain points in time (e.g., a pathway that may have been extremely popular or one that may have become extremely popular may be more or less relevant at present).

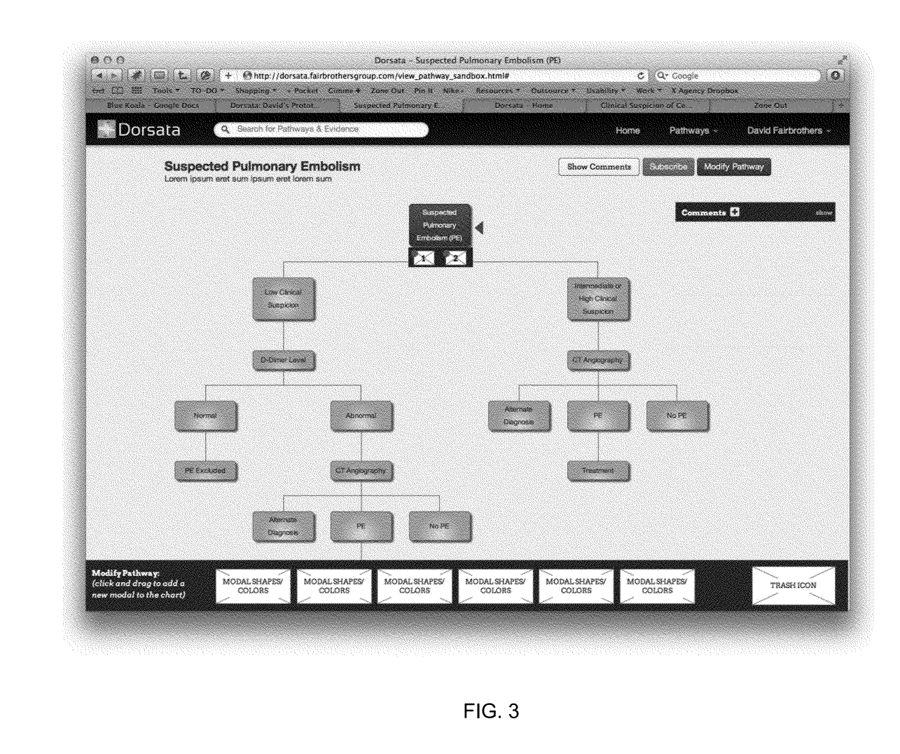

The Platform may be engineered to deliver search results that collect and leverage data from a number of sources, both implicit and explicit, to deliver hyper accurate and relevant pathways. For example, a user may submit the following query to the platform “child+headache+fever” and the Platform may return results that contain one or all of the terms in the query. In some alternatives, a user or third-party application or database may submit data or algorithms as a search query to the Platform. The Platform could be used to ask the user or a third party application to input additional relevant information as they actually see a patient based on existing pathways in the Platform. For example, a physician may enter “suspected pulmonary embolism” into a query field available on the Platform. Using data from a clinical pathway in the Platform as illustrated in FIG. 3, the Platform may prompt the physician for additional information, such as D-dimer level, estimated clinical probability of PE, prior imaging studies, or other information related to the diagnosis of pulmonary embolisms using checkboxes, radio graphs, buttons, text fields or any conventional data input field.

The Platform may allow for users to see the variance between similar pathways in a visual manner as well as the ability for users to see the evolution of a particular pathway's development over time in a visual manner. For example, individual nodes inside of pathways may have different background colors, which may be representative of node types (e.g., procedure, diagnostic test, diagnosis etc.) or different shapes (e.g., square, circle, triangle) to visualize node types (e.g., procedure, diagnostic test, diagnosis etc.). Node colors and shapes may be selected by the user or determined based on analysis of the node's content by the Platform. The Platform may determine the colors and shapes of individual nodes based on the underlying data associated with each particular node. This underlying data may be derived from ICD-11, SNOMED, and CPT codes. In some alternatives, the colors and shapes of the nodes may be used to visualize how a node in specific pathway compares with the nodes in a similar pathway. In some alternatives, the colors and shapes of the nodes may be used visualize the individual contributions by specific users to a collaboratively developed pathway (i.e., a pathway that has been edited by numerous users). In some alternatives, the colors and shapes of the nodes may be used to visualize how the nodes within a pathway have changed over time. Varying colors and shapes may show nodes that have been recently added or modified and other colors may show nodes that may not have change for a certain amount of time. For example, the user may be able to layer multiple pathways on top of each other, where similarities are distinguished in one series of shapes and/or colors and differences are displayed in other shapes and/or colors. One pathway may suggest a CT Angiography at a certain point in the pathway and another may suggest a D-Dimer Test. These differences in data may be visualized using colors and/or shapes. Two or more pathways may be compared by merging the pathways and using colors to highlight differences (e.g., yellow & blue) and similarities (e.g., green) between the various steps within pathways. This comparison may be used to rapidly demonstrate where two or more pathways diverge such that a clinician may identify areas where there is general consensus versus disagreement in the approach to a clinical problem.

In some alternatives, the various steps of a clinical pathway or nodes of a clinical pathway may be associated with one or more medical terminology or translated into one or more data formats for the exchange of data with other electronic clinical systems. The Platform may allow for the direct, node to node navigation through pathways.

### Networks

In some embodiments of the invention, the Platform may provide users with the ability to create a community of one or more custom networks. Custom networks may include entities, such as a hospital system, a subspecialty society, clinical department, university, medical school, research entity or clinical practice group. In some alternatives, the custom networks may have their own security, permissions, users, administrators and private clinical pathways. In some alternatives, the custom networks may have publicly available pathways. In some alternatives, the custom networks may be shared by one or more entities. These networks may serve as pathway working groups, in which multiple pathways may be edited and shared with other network members. These networks may be able to be designated as private (only open to users who have been specifically invited by network administrators) or public (open to all users, system-wide). In some alternatives, the users may be able to designate privacy settings for pathways. These privacy settings may be used to control access to the pathway by other users. For example, a pathway may be published to specific networks and/or working groups and/or to specific users. If a particular user has not been granted access to a specific pathway, they may not be able to view the underlying data, relationships, and content contained in the pathway. This user may be able to request access to the restricted pathway. If the request is granted by a pathway contributor, then the user may be able to access the restricted pathway.

### Updating a Pathway

In some alternatives, as illustrated in FIGS. 11-22, the Platform may provide users with the ability to modify a new or existing clinical pathway by adding nodes in an ad-hoc fashion to account for any unknown or unpredictable conditions that may arise with a particular patient or patients. In some alternatives, a user may be able to delete nodes from a pathway by dragging and dropping the node into the Platform's deletion target area. In some alternatives, the Platform may algorithmically encourage the collaborative modifications and additions to pathways by networks of users. In some alternatives, Updates to a specific pathway by a user may be collected and delivered to all other users who may be associated with that pathway through network association, pathway subscription, or by being an approved collaborator. The collection and delivery may occur through an organized interface that may list the updates chronologically. A user who may be building the pathway may be able to associate long-term or short-term patient health outcome data and patient cost data to pathways. The user who may be viewing a pathway may be able to view patient outcomes and cost data which is associated to that pathway.

In some alternatives, the Platform may store and organize data regarding the evolution of pathways, which reside in the Platform's database. The Platform may store data items on a node by node basis, storing historical textual content, and associated items (e.g., videos, images, documents, cited evidence etc.). In some alternatives, the Platform may store usage data per pathway or per pathway version. This means that each version of a given pathway may have a specific record of how much user interaction may have occurred within each version.

In some alternatives, the user may be able to copy steps from one pathway to another pathway in the Platform. For example, when a user changes a step, adds/deletes content, etc. to a node, the same step, content, etc. may be added/deleted to the companion node(s) in the “mirror image” or “cloned” branch.

### Collaboration on a Pathway

Multiple users may have privileges to edit, modify, update, and distribute certain pathways which reside in the database. In this manner, the Platform may drive collaboration by delivering updates and changes to pathways to the associated users through pathway updates. For example, a specific user may desire to work on a single pathway with multiple colleagues. To achieve this, the user may simply invite the desired colleagues using a tool provided by the Platform. The user may enter the desired colleagues' email addresses and a uniquely identifiable link would be sent to them. When the colleague clicks the link, he or she may be able to access the content by signing up for a Platform user account or log in with an existing user account. After accepting the invitation, the colleague may have access to the Platform to modify the pathway. All changes in the particular pathway may be seen by other approved contributors.

Integrating a Pathway with EMR

In some embodiments of the invention, the Platform may interface with an Electronic Medical Record (EMR) system using any conventional means. In some alternatives, the interface may be used to automate the input of data from the EMR to the Platform. In some alternatives, a user may submit query based on data from an EMR related to a patient encounter, such as demographics, past medical history, medications, lab results or other data to the Platform, which may provide results that may suggest one or more appropriate clinical pathways which are appropriate for management, ideally personalized based on a provider's institution, specialty, prior usage, known patient preferences, etc. In some embodiments of the invention, outcome data on pathway use may be obtained through the interface with the one or more EMR systems. For example, if the user would like to know if the “Dartmouth Hip Pain Pathway” has been used 400 times during the last 6 months at 12 institutions. An interaction with the EMR may provide the following outcome data, 75% of patients were managed non-operatively with an additional 25% of patients undergoing hip replacement surgery with an average cost of $26K per patient. In some alternatives, the user may be able to populate a patient's electronic medical record by clicking through a graphical pathway during the course of care.

### Other Uses for the Platform

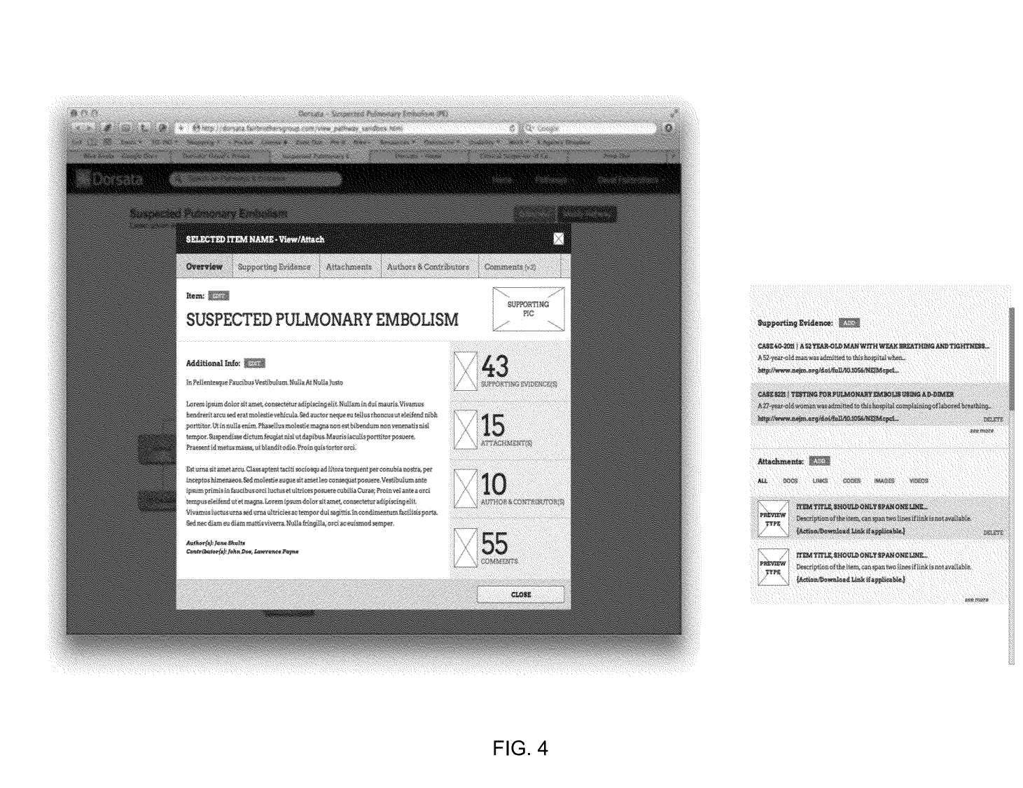

In some embodiments of the invention, the user-generated pathways created with the Platform may be used to build a computerized decision-support system. For example, as illustrated in FIG. 4, in the field of radiology, users of the Platform or computerized decision-support system may build a diagnostic algorithm for cerebellopontine angle (CPA) lesions. As the algorithm is used and validated in clinical practice, the Platform may eventually be able to use data from this algorithm to formulate a complementary computer-based system to assist in detection of imaging pathology, i.e., train a computer to localize the cerebellopontine angle on MRI studies, assess for asymmetry or mass lesions, then apply the algorithm in assessing the lesions signal characteristics to formulate an appropriate differential diagnosis. Over time, users may attach relevant content or other data to the clinical pathway, which may be the basis for the algorithm and with integration to the EMR, results may be associated with the ultimate findings at pathology. This data could then be used to populate computer detection algorithms which might automate some of the processes of image interpretation using conventional image query techniques. In some alternatives, the Platform may use conventional syntaxes, standardized language or data interchange formats to translate the language of the pathways that the clinicians build into one or more standardized language used to construct medical logic modules which can be used to automate decision support. In some alternatives, the Platform may harnesses the social network to create a system which has the ability to rapidly learn and disseminate best practices.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A computer-implemented method for the collaborative creation and maintenance of electronic clinical pathways, the method comprising the computer-implemented steps of:
receiving a request for one or more clinical pathways from a user;
displaying the requested one or more clinical pathways to the user;
updating one or more nodes on the displayed one or more clinical pathways, wherein each of the one or more nodes has content from at least one source;
storing the updated one or more clinical pathways;
identifying members from one or more networks to revise the updated one or more clinical pathways;
submitting the updated one or more clinical pathways to the identified members;
receiving a revised one or more clinical pathways from the identified member;
notifying the user about the availability of the revised one or more clinical pathways; and
displaying the revised one or more clinical pathways to the user.

2. The computer-implemented method of claim 1, wherein the clinical pathway is selected from the group consisting of: new clinical pathways, existing clinical pathways and combinations thereof.

3. The computer-implemented method of claim 1, wherein the content is selected from the group consisting of: images, videos, external links, cited evidence, published journal articles, related guidelines from subspecialty societies or governments, user comments, institutional protocols, ICD-11 codes, SNOMED codes, CPT codes, links to additional pathways and combinations thereof.

4. The computer-implemented method of claim 1, wherein the one or more nodes have an underlying relationship stored in a database.

5. The computer-implemented method of claim 1, wherein the one or more nodes are visually represented by colors and shapes, wherein each color or shape may represent the type of node, comparison with other nodes or the evolution of the one or more nodes.

6. The computer-implemented method of claim 1, wherein the one or more nodes is associated with patient outcome data and patient care costs.

7. A computer-implemented method for dynamically ranking search results for clinical pathways, the method comprising the computer-implemented steps of:
receiving a request for one or more clinical pathways from a user, wherein the request contains one or more search terms;
submitting the request as queries to one or more databases associated with objects of clinical pathways;
querying the one or more databases for ranking criteria for the requested one or more clinical pathways;
receiving the ranking criteria from the one or more databases;
ranking results from the queries based on the received ranking criteria; and
displaying the ranked results to the user.

8. The computer-implemented method of claim 7, wherein the clinical pathway is selected from the group consisting of: new clinical pathways, existing clinical pathways and combinations thereof.

9. The computer-implemented method of claim 7, wherein the one or more databases are selected from the group consisting of: internal databases, third-party applications, third party-databases and combinations thereof.

10. The computer-implemented method of claim 7, wherein the ranking criteria is a user feedback loop.

11. The computer-implemented method of claim 10, wherein the user feedback loop consists of data selected from the group consisting of: the user's interaction with a pathway, the user's interactions with the results from the query, the user ratings of clinical pathways, a sentiment analysis of the user's submitted comments, other pathways the user has accessed or combinations thereof.

12. The computer-implemented method of claim 7, wherein the ranking criteria is based on usage data for the one or more clinical pathways.

13. The computer-implemented method of claim 12, wherein the usage data is selected from the group consisting of: number of times the one or more clinical pathways has been accessed, network memberships and affiliations for the one or more clinical pathways, user subscriptions to the one or more clinical pathways, time spent browsing the one or more clinical pathways, number of time the one or more clinical pathways have been used to update other pathways, internal rankings of the one or more clinical pathways by contributors, number of nodes contained in a pathway, explicit and implicit signals, historical usage data and combinations thereof.

14. The computer-implemented method of claim 13, wherein the internal rankings is selected from the group consisting of: number of the one or more clinical pathways published, number of subscribers to the one or more clinical pathways, the number of times the one or more pathways have been used to update other pathways and combinations thereof.

15. The computer-implemented method of claim 13, wherein the historical usage data indicates the relevance of the one or more clinical pathways at a particular point in time.

16. A computer-implemented method for visually comparing at least two clinical pathways, the method comprising the computer-implemented steps of:
receiving a request for a first clinical pathways from a user;
receiving a request for a second clinical pathway from a user;
displaying nodes for the first clinical pathway to the user;
displaying nodes for the second clinical pathway to the user;
comparing the nodes from the first clinical pathway with the nodes from the second clinical pathway; and
highlighting differences and similarities from the comparison with one or more colors.

17. The computer-implemented method of claim 16, wherein the nodes comprise various colors and shapes.

18. The computer-implemented method of claim 17, wherein the various colors and shapes represent a function of the nodes, contributions to nodes by individual users or evolution of the nodes over time.

19. The computer-implemented method of claim 18, wherein the function is selected from the group consisting of: procedures, diagnostic tests, diagnosis, other functions and combinations thereof.

20. The computer-implemented method of claim 17, wherein the various colors and shapes are dynamically assigned based on an analysis of content within the nodes.
